(19) United States
(12) Patent Application Publication
(10) Pub. No.: US 2009/0096562 A1
(43) Pub. Date: Apr. 16, 2009

(54) HIGH-VOLTAGE TRANSFORMER

(76) Inventors: Toshihiro Nakadai, Oaska (JP); Hisao Yamashita, Osaka (JP); Takaya Nagai, Kyoto (JP)

Correspondence Address: WENDEROTH, LIND & PONACK L.L.P., 2033 K. STREET, NW, SUITE 800, WASHINGTON, DC, 20006, US

(21) Appl. No.: 12/297,380

(22) PCT Filed: Apr. 17, 2007
(86) PCT No.: PCT/JP2007/058317

§ 371 Date: Oct. 16, 2008

(30) Foreign Application Priority Data
Apr. 20, 2006 (JP) 2006 116425
May 18, 2006 (JP) 2006 138448
Jun. 7, 2006 (JP) 2006 158185
Jun. 22, 2006 (JP) 2006 172142

(51) Int. Cl. H01F 27/06

(52) U.S. Cl. 336/67

(57) ABSTRACT

A high-voltage transformer includes a core, a coil part, a diode holder, a component block, and a substantially rectangular parallelepiped shaped outer case for accommodating the coil part, the diode holder, and the component block. The coil part includes a coil bobbin into which the core is inserted, and windings wound around the coil bobbin. The diode block includes a plurality of diodes connected to the windings, and a member for holding the diodes. The component block includes electrical components connected to the windings, and a member on which the electrical components are fixedly arranged. The high-voltage transformer is low-profile and small in size.

### TECHNICAL FIELD

The present invention relates to a high-voltage transformer which generates a direct current high voltage.

### BACKGROUND ART

FIG. 35A and FIG. 35B show a side view and a plan view, respectively, of conventional high-voltage transformer 4580 disclosed in Patent Document 1 below. In high-voltage transformer 4580, coil part 4505, diode holder 4530, and focus volume 4570 are combined together and housed in substantially cylindrical outer case 4540. Outer case 4540, which is made of plastic resin, is filled with insulating resin.

High-voltage transformer 4580 includes core 4500, primary coil bobbin 4510 fitted around the shaft of core 4500, and secondary coil bobbin 4520 fitted around the outer periphery of primary coil bobbin 4510. Primary coil bobbin 4510 has a primary winding wound thereon, and secondary coil bobbin 4520 has a secondary winding divided into a plurality of portions and wound thereon. The plurality of portions of the secondary winding are arranged alternately with insulator films. Core 4500, primary coil bobbin 4510, the primary winding, secondary coil bobbin 4520, the secondary winding, and the insulator films together form coil part 4505. Diode holder 4530 includes a plurality of diodes 4531, high-voltage splicing fitting 4532, and protection resistor 4575. Focus volume 4570 includes high-voltage capacitor 4571 and high-voltage resistor 4572.

Outer case 4540 includes cylindrical part 4542 for accommodating coil part 4505. Cylindrical part 4542 and coil part 4505 have the same center. The secondary winding of secondary coil bobbin 4520 and the inner surface of cylindrical part 4542 have a constant distance therebetween.

Outer case 4540 has opening 4543 from which low-voltage terminal pins 4550 included in primary coil bobbin 4510 protrude. Low-voltage terminal pins 4550 are electrically connected to printed-circuit board 4560 by being inserted into the holes thereof.

When high-voltage transformer 4580 is disposed on printed-circuit board 4560, the height from its top to printed-circuit board 4560 is large. Diode holder 4530 is disposed perpendicular to core 4500, and therefore, high-voltage transformer 4580 has a larger outer diameter.

Focus volume 4570 including high-voltage capacitor 4571 and high-voltage resistor 4572 is fixed to side opening 4541 of outer case 4540. Focus volume 4570 including high-voltage capacitor 4571 and high-voltage resistor 4572 has a sufficient insulation distance from a transformer body including diode holder 4530, that is, diodes 4531. High-voltage components such as high-voltage capacitor 4571 and high-voltage resistor 4572 are in fixed contact with focus volume case 4574.

Primary coil bobbin 4510, secondary coil bobbin 4520, and diode holder 4530 together form the transformer body. Diode holder 4530 includes high-voltage splicing fitting 4532. Focus volume 4570 includes high-voltage connection pin 4573. The high-voltage ends of the transformer body and the components included in focus volume 4570 are connected to each other by inserting high-voltage connection pin 4573 into high-voltage splicing fitting 4532. Diode holder 4530 is attached to primary and secondary coil bobbins 4510, 4520 and housed in substantially cylindrical outer case 4540. Then, focus volume 4570 is attached to side opening 4541 of outer case 4540, thus allowing high-voltage connection pin 4573 to be inserted into and connected to high-voltage splicing fitting 4532.

FIG. 36 is a circuit diagram of high-voltage transformer 4580. Core 4500, primary winding 4511, secondary winding 4521, diodes 4531, and protection resistor 4575 together form the transformer body of high-voltage transformer 4580. Focus volume 4570 includes high-voltage capacitor 4571 and high-voltage resistor 4572.

When high-voltage transformer 4580 is used as a flyback transformer in a display device using a cathode-ray tube, protection resistor 4575 is supplied with a small current of 2 to 3 mA. Protection resistor 4575 supplied with such a small current has nearly the same shape and size as diodes 4531. Protection resistor 4575 is generally included together with diodes 4531 in diode holder 4530, thus hardly affecting the size of high-voltage transformer 4580.

The height of high-voltage transformer 4580 from its top to printed-circuit board 4560 and the outer diameter of high-voltage transformer 4580 are both large. This is because high-voltage transformer 4580 is disposed in such a manner that the longitudinal direction of primary coil bobbin 4510 is perpendicular to printed-circuit board 4560.

In a flat-screen TV, printed-circuit board 4560 is vertically disposed, and therefore, using high-voltage transformer 4580 in such a flat-screen TV increases its depth. However, there is no need to consider the insulation distance between printed-circuit board 4560 and high-voltage transformer 4580 because printed-circuit board 4560 is in contact with a low-voltage bottom surface of high-voltage transformer 4580.

In focus volume case 4574, the part including the high-voltage components in focus volume 4570 may be peeled from the insulating resin due to variations in the coefficient of expansion or adhesion of the insulating resin to be contained in outer case 4540.

The high-voltage components and focus volume case 4574 have a creepage distance therebetween long enough to provide insulation. However, when focus volume case 4574 has a material adhered thereon which inhibits the adhesion between the insulating resin and itself, a high voltage may leak along the interface between the part including the high-voltage components in focus volume 4570 and the insulating resin.

Therefore, in case of a high-voltage leakage, in printed-circuit board 4560 mounted with high-voltage transformer 4580, the electrical components are generally disposed a certain distance away from the periphery of high-voltage transformer 4580. In the case where high-voltage transformer 4580 is used as a flyback transformer in a display device using a cathode-ray tube, high-voltage transformer 4580 generates a high voltage of 20 kV to 33 kV. In this case, the spatial distance between high-voltage transformer 4580 and the peripheral components can be about 10 mm to 15 mm, making printed-circuit board 4560 larger in size.

Focus volume 4570 has a solid shape and is attached to side opening 4541 of outer case 4540 so as to eliminate distortion of outer case 4540. This ensures the insulation distance between the high-voltage parts such as the secondary winding and diodes 4531 in high-voltage transformer 4580 and substantially cylindrical outer case 4540.

The high-voltage finish ends of the transformer body and the components in focus volume 4570 are connected to each other by inserting connection pin 4573 into high-voltage splicing fitting 4532. After the transformer body is assembled in outer case 4540, focus volume 4570 is attached to side opening 4541 of outer case 4540, so that high-voltage connection pin 4573 of focus volume 4570 can be connected to high-voltage splicing fitting 4532 of diode holder 4530. However, while focus volume 4570 is being attached to outer case 4540, the inside of the transformer body cannot be visually recognized. Therefore, when high-voltage connection pin 4573 varies in size, it might be impossible to connect the transformer body and focus volume 4570.

High-voltage splicing fitting 4532 is formed by processing a planar metal. To make high-voltage splicing fitting 4532 securely held by diode holder 4530 and to facilitate the insertion of high-voltage connection pin 4573 thereinto, high-voltage splicing fitting 4532 may be formed into a complex shape, possibly increasing the costs of the components and the mold.

FIG. 37A and FIG. 37B are a sectional side view and a bottom view, respectively, of converter transformer 8031, which is a conventional high-voltage transformer disclosed in Patent Document 2 below.

Converter transformer 8031 includes core 4910, bobbin 4120 disposed on the outer periphery of core 4910, and primary and secondary windings 4130 each divided into a plurality of layers and wound around bobbin 4120. Between the layers of windings 4130, there is insulating tape 4132A wound to insulate the layers.

Bobbin 4120 has terminal pins 4140 extending downwardly from the bottom surface thereof. Converter transformer 8031 further includes printed-circuit board 4200 mounted with primary circuit component 4212 and secondary circuit component 4220. Terminal pins 4140 are solder-joined to through-holes 4202 of printed-circuit board 4200. Core 4910, bobbin 4120, the windings 4130, and printed-circuit board 4200 together form a transformer body.

The transformer body is inserted into substantially rectangular insulating case 4950, which is filled with insulating filler 4400.

Terminal pins 4140 extending from the opening of insulating case 4950 are solder-joined to through-holes 4802 of mount substrate 4800.

In converter transformer 8031, printed-circuit board 4200, which is mounted with primary and secondary circuit components 4212, 4220 and provided with electric wiring, is disposed between transformer bobbin 4120 and mount substrate 4800 in insulating case 4950. This increases the distance from mount substrate 4800 to the top panel of insulating case 4950.

FIG. 38 is a front view of primary coil bobbin 5060 of a conventional high-voltage transformer disclosed in Patent Document 3 below. Primary coil bobbin 5060 includes pin holders 5061, terminal pins 5062, and primary winding 5069. Terminal pins 5062 each include winding portion 5064 and printed-circuit board insertion portion 5065. Terminal pins 5062 are inserted into and held by pin holders 5061. Primary winding 5069 has ends 5067, which are wound around winding portions 5064 at the bases of terminal pins 5062.

FIG. 39 is a schematic diagram showing how to connect ends 5067 of primary winding 5069 to terminal pins 5062 inserted into pin holders 5061. Primary coil bobbin 5060 is moved in the arrow direction to soak terminal pins 5062 in solder bath 5071 containing molten solder 5072. Terminal pins 5062 are soaked up to winding portions 5064 around which ends 5067 of primary winding 5069 are wound. Thus, terminal pins 5062 and ends 5067 are connected by solder dipping.

FIG. 40 is a front view of primary coil 8042 of a high-voltage transformer disclosed in Patent Document 4 below. In primary coil 8042, primary coil bobbin 5160 includes primary winding 5169, substantially L-shaped terminal pins 5170, pin holders 5161, and hook grooves 5168. Pin holders 5161 hold terminal pins 5170. Terminal pins 5170 each include winding portion 5163 and printed-circuit board insertion portion 5173.

Terminal pins 5170 are inserted into and held by pin holders 5161. Primary winding 5169 has ends 5167, which are wound around winding portions 5163 at one end of terminal pins 5170.

FIG. 41 is a schematic diagram showing how to connect ends 5167 of primary winding 5169 to terminal pins 5170. Solder bath 5171 contains molten solder 5172. Primary coil bobbin 5160 is moved in the downward direction shown by the arrow so as to soak terminal pins 5170 in molten solder 5172 up to winding portions 5163. As a result, ends 5167 are connected to terminal pins 5170 by solder dipping.

FIG. 42 is a bottom view of primary coil bobbin 5160 when seen in direction 5160A in FIG. 41. Primary coil bobbin 5160 includes a hollow cylindrical part having center 5177.

Primary coil bobbin 5160 is moved in direction 5160B to soak terminal pins 5170 in molten solder 5072 up to winding portions 5163, thereby connecting ends 5167 to terminal pins 5170 by solder dipping. Then, primary coil bobbin 5160 is rotated about center 5177 either in direction 5160C or 5160D opposite thereto. As a result, winding portions 5163 of all terminal pins 5170 around which ends 5167 are wound are connected to ends 5167 in the same manner by solder dipping.

FIG. 43 is a front view of primary coil bobbin 5060 of FIG. 38 mounted on printed-circuit board 5078. Primary coil bobbin 5060 has height 5079 from printed-circuit board 5078. Primary coil bobbin 5060 is disposed so that its longitudinal direction is perpendicular to printed-circuit board 5078. This results in large height 5079 from the surface of printed-circuit board 5078 to the top of high-voltage transformer 8041.

When high-voltage transformer 8041 is used in a flat-screen TV, printed-circuit board 5078 is vertically disposed in parallel with the display device, thus increasing the depth of the TV.

In primary coil bobbin 5060 shown in FIGS. 38 and 39, ends 5067 of primary winding 5069 are wound around winding portions 5064 at the bases of the terminal pins. As shown in FIG. 39, when terminal pins 5062 and ends 5067 are soaked in molten solder 5072, the long portions of terminal pins 5062 are soaked in molten solder 5072. This causes the heat from the solder to conduct from terminal pins 5062 to pin holders 5061, possibly softening pin holders 5061 of coil bobbin 5060 made of plastic resin. If pin holders 5061 of primary coil bobbin 5060 are softened, terminal pins 5062, which is subjected to the force of primary winding 5069, displace in the direction in which the force is applied. Inclined terminal pins 5062 cannot be smoothly inserted into the holes formed in printed-circuit board 5078, making it harder to mount high-voltage transformer 8041 on printed-circuit board 5078. Furthermore, it becomes necessary to inspect all the products to find and eliminate high-voltage transformers 8041 including greatly inclined terminal pins 5062.

In primary coil 8042 of FIGS. 40 and 41, on the other hand, substantially L-shaped terminal pins 5170 are not greatly inclined. The reason for this is as follows. Primary winding 5169 is wound around terminal pins 5170 via hook grooves 5168, which function to reduce the tension applied to terminal pins 5170 and to prevent them from being inclined. In primary coil 8042, however, as shown in FIG. 42, winding portions 5163 of terminal pins 5170 are radially arranged from center 5177 of primary coil bobbin 5160. This requires a larger number of solder dipping processes because primary coil bobbin 5160 needs to be moved in direction 5160B and rotated in direction 5160C (5160D) so as to soak terminal pins 5170 around which ends 5167 of primary winding 5169 are wound in molten solder 5172. Moreover, the substantially L-shaped terminal pins 5170 are difficult to process because of the complex shape. In addition, both the insertion of terminal pins 5170 into primary coil bobbin 5160 and the winding of primary winding 5169 around terminal pins 5170 are complex, increasing the cost and the number of man-hours.
Patent Document 1: Japanese Patent Unexamined Publication No. 2001-176727
Patent Document 2: Japanese Patent Unexamined Publication No. 2000-060125
Patent Document 3: Japanese Patent Unexamined Publication No. S62-025807
Patent Document 4: Japanese Patent Unexamined Publication No. H08-008132

### SUMMARY OF THE INVENTION

A high-voltage transformer includes a core, a coil part, a diode holder, a component block, and a substantially rectangular parallelepiped shaped outer case for accommodating the coil part, the diode holder, and the component block. The coil part includes a coil bobbin into which the core is inserted, and windings wound around the coil bobbin. The diode block includes a plurality of diodes connected to the windings, and a member on which the diodes are arranged. The component block includes electrical components connected to the windings, and a member on which the electrical components are arranged. The high-voltage transformer is low-profile and small in size.

### BRIEF DESCRIPTION OF THE DRAWINGS

FIG. 1A is a schematic diagram of a high-voltage transformer according to a first embodiment of the present invention.

FIG. 1B is a sectional view of the high-voltage transformer taken along line 1B-1B of FIG. 1A.

FIG. 2 is a partially enlarged view of the high-voltage transformer according to the first embodiment.

FIG. 3A is a schematic diagram of the high-voltage transformer according to the first embodiment in which a diode holder is attached to a coil part.

FIG. 3B is another schematic diagram of the high-voltage transformer according to the first embodiment in which the diode holder is attached to the coil part.

FIG. 4A is a schematic diagram of the diode holder of the high-voltage transformer according to the first embodiment.

FIG. 4B is a sectional view of the diode holder taken along line 4B-4B of FIG. 4A.

FIG. 5A is a front view of a component block of the high-voltage transformer according to the first embodiment.

FIG. 5B is a rear side view of the component block of FIG. 5A.

FIG. 5C is a bottom view of the component block of FIG. 5A.

FIG. 6 is a circuit diagram of the high-voltage transformer according to the first embodiment.

FIG. 7 is a sectional view of a high-voltage transformer according to a second embodiment of the present invention.

FIG. 8 is a sectional view of the high-voltage transformer taken along line 8-8 of FIG. 7.

FIG. 9 is a circuit diagram of the high-voltage transformer according to the second embodiment.

FIG. 10 is a sectional view of a high-voltage transformer according to a third embodiment of the present invention.

FIG. 11A is a front view of a primary coil bobbin of the high-voltage transformer according to the third embodiment.

FIG. 11B is a bottom view of the primary coil bobbin according to the third embodiment.

FIG. 12 is a configuration diagram of a flat-screen TV having the high-voltage transformer according to the third embodiment.

FIG. 13 is a schematic diagram showing a method for manufacturing the high-voltage transformer according to the third embodiment.

FIG. 14 is a perspective view of a pin holder of the high-voltage transformer according to the third embodiment.

FIG. 15 is a front view of the pin holder according to the third embodiment.

FIG. 16 is a sectional view of the pin holder taken along line 16-16 of FIG. 15.

FIG. 17A is a sectional view of the pin holder taken along line 17A-17A of FIG. 15.

FIG. 17B is a sectional view of the pin holder taken along line 18B-18B of FIG. 15 in the state of holding a terminal pin.

FIG. 18A is a sectional view of another type of pin holder according to the third embodiment.

FIG. 18A is a sectional view of the pin holder of FIG. 18A in the state of holding a terminal pin.

FIG. 19A is a sectional view of another type of pin holder according to the third embodiment.

FIG. 19B is a sectional view of the pin holder of FIG. 19A in the state of holding a terminal pin.

FIG. 20A is a front view of a pin holder of a high-voltage transformer according to a fourth embodiment of the present invention.

FIG. 20B is a sectional view of the pin holder taken along line 20B-20B of FIG. 20A.

FIG. 20C is a sectional view of the pin holder in the state of holding a terminal pin.

FIG. 20D is a sectional view of the pin holder taken along line 20D-20D of FIG. 20A.

FIG. 21A is a front view of a pin holder of a high-voltage transformer according to a fifth embodiment of the present invention.

FIG. 21B is a sectional view of the pin holder taken along line 21B-21B of FIG. 21A.

FIG. 21C is a sectional view of the pin holder in the state of holding a terminal pin.

FIG. 22 is a sectional view of the pin holder taken along line 22-22 of FIG. 21A.

FIG. 23 is a perspective view of a high-voltage transformer according to a sixth embodiment of the present invention.

FIG. 24 is a schematic diagram of the high-voltage transformer according to the sixth embodiment in the state of being mounted on a printed-circuit board.

FIG. 25 is a perspective view of a primary coil bobbin of the high-voltage transformer according to the sixth embodiment.

FIG. 26 is a perspective view of a secondary coil bobbin of the high-voltage transformer according to the sixth embodiment.

FIG. 27 is a perspective view of a printed-circuit board of the high-voltage transformer according to the sixth embodiment.

FIG. 28 is a perspective view of an outer case of the high-voltage transformer according to the sixth embodiment.

FIG. 29 is a perspective view of a high-voltage transformer according to a seventh embodiment of the present invention.

FIG. 30 is a perspective view of a high-voltage transformer according to the seventh embodiment.

FIG. 31 is a bottom view of a high-voltage transformer according to an eighth embodiment of the present invention.

FIG. 32 is a perspective view of a high-voltage transformer according to a ninth embodiment of the present invention.

FIG. 33 is a bottom view of a high-voltage transformer of a tenth embodiment of the present invention.

FIG. 34 is a bottom view of a high-voltage transformer according to an eleventh embodiment of the present invention.

FIG. 35A is a side view of a conventional high-voltage transformer.

FIG. 35B is a plan view of the high-voltage transformer of FIG. 35A.

FIG. 36 is a circuit diagram of the high-voltage transformer of FIG. 35A.

FIG. 37A is a sectional side view of another conventional high-voltage transformer.

FIG. 37B is a bottom view of the high-voltage transformer of FIG. 37A.

FIG. 38 is a front view of a primary coil bobbin of another conventional high-voltage transformer.

FIG. 39 is a schematic diagram showing a method for manufacturing the high-voltage transformer of FIG. 38.

FIG. 40 is a front view of a primary coil of another conventional high-voltage transformer.

FIG. 41 is a schematic diagram showing a method for manufacturing the high-voltage transformer of FIG. 40.

FIG. 42 is a bottom view of the high-voltage transformer of FIG. 41.

FIG. 43 is a front view of the high-voltage transformer of FIG. 38 mounted on a printed-circuit board.

### REFERENCE MARKS IN THE DRAWINGS

1020 primary coil bobbin
1026 rib (second rib)
1027 rib (first rib)
1040 secondary coil bobbin
1080 outer case
1081 opening
1089 side surface
1090 board
3010 core
3025 primary coil bobbin
3035 secondary coil bobbin
3020 primary winding
3030 secondary winding
300 coil part
3040 diode
3045 diode holder
3100 block
3240 outer case
3301 center line of the coil bobbin
3246 side surface of the outer case (second side surface)
3241 side surface of outer case (first side surface)
4010 core
4011 bar of the core (second bar)
4012 bar of the core (first bar)
4020 primary winding
4025 primary coil bobbin
4030 secondary winding
4035 secondary coil bobbin
4040 diode
4041 lead wire of a diode
4042 holder substrate (first member)
4045 diode holder
4046 hollow hole of the holder substrate
4049 square hole of the holder substrate
4050 high-voltage capacitor (electrical component)
4055 high-voltage capacitor (electrical component)
4060 ceramic substrate resistor (electrical component)
4065 ceramic substrate resistor (electrical component)
4070 high-voltage protection resistor (electrical component)
4075 high-voltage protection resistor (electrical component)
4110 component substrate (second member)
4100 component block
4150 projection of the component substrate
4152 engaging portion of the component substrate
4211 connection pin
4230 conductive rubber
4240 outer case
4254 terminal pin (first terminal pin)
4250 terminal pin (second terminal pin)
4242 aperture plane of the outer case
4244 protruding part of the outer case
4270 insulating resin
4300 coil part
5001 primary coil bobbin
5002 pin holder
5003 terminal pin
5004 primary winding
5005 end of a terminal pin (first end)
5006 end of a terminal pin (second end)
5008 case
5013 insulating resin
5017 central region of the terminal pin
5031 core
5042 groove (first groove)
5043 groove (second groove)
5047 groove (second groove)
5048 groove (second groove)
5102 pin holder
5202 pin holder
5302 pin holder
5302B pin holding projection
5302L pin holding rib (first pin holding rib)
5302R pin holding rib (second pin holding rib)
5346U holding rib (first holding rib)
5346D holding rib (first holding rib)
5402 pin holder
5402B pin holding projection
5402L pin holding rib (first pin holding rib)
5402R pin holding rib (second pin holding rib)
7301D printed-circuit board (board)

### DETAILED DESCRIPTION OF PREFERRED EMBODIMENTS

### First Embodiment

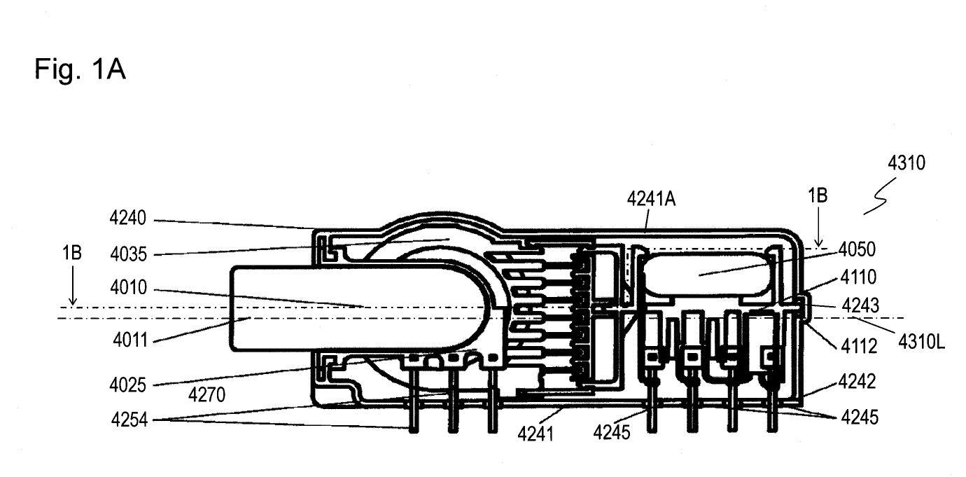

FIG. 1A is a schematic diagram of high-voltage transformer 4310 according to a first embodiment of the present invention. FIG. 1B is a sectional view of high-voltage transformer 4310 taken along line 1B-1B of FIG. 1A. High-voltage transformer 4310 includes coil part 4300, diode holder 4045, and component block 4100, which are combined together and housed in substantially rectangular outer case 4240. Outer case 4240, which is molded from plastic resin, is filled with insulating resin 4270 such as epoxy resin.

Coil part 4300, diode holder 4045, and component block 4100 are arranged in straight line 4310L in this order, and together form a transformer body.

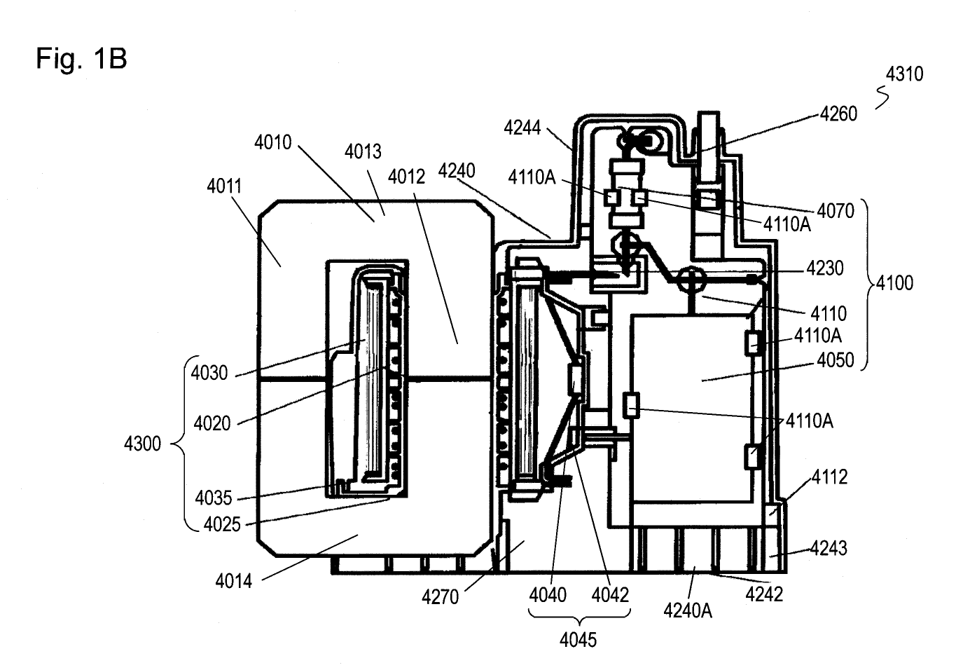

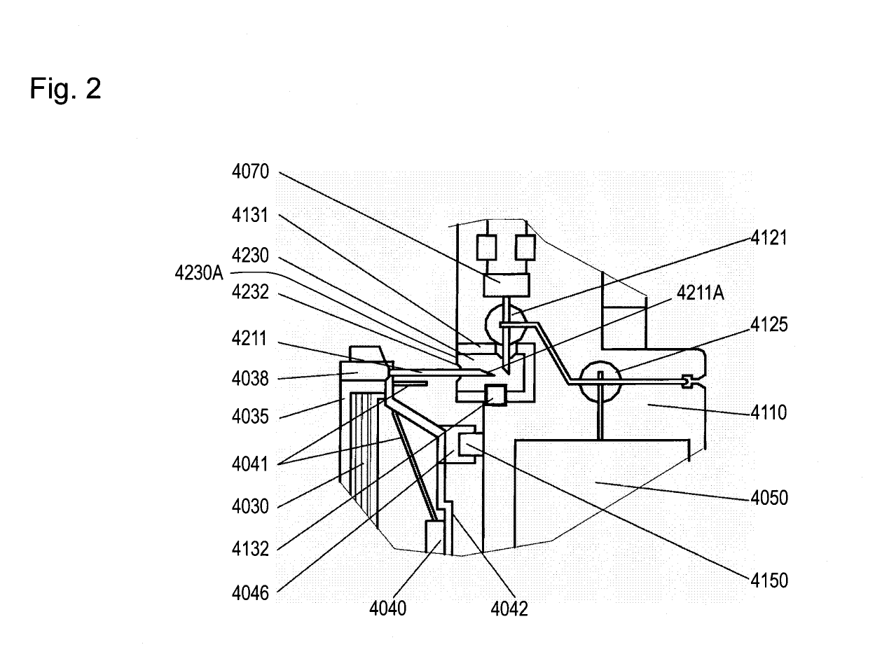

FIG. 2 is a partially enlarged view of high-voltage transformer 4310. FIGS. 3A and 3B are schematic diagrams in which diode holder 4045 is attached to coil part 4300 of high-voltage transformer 4310. Coil part 4300 includes primary coil bobbin 4025, primary winding 4020, terminal pins 4254, secondary coil bobbin 4035, secondary windings 4030, terminal pins 4210, and connection pin 4211. Connection pin 4211 has tip 4211A, which is pointed like a needle.

In coil part 4300, primary coil bobbin 4025 is fitted around the shaft of core 4010, and primary winding 4020 is wound around primary coil bobbin 4025. Secondary coil bobbin 4035 is fitted around the outer periphery of primary coil bobbin 4025, and secondary windings 4030 are wound around secondary coil bobbin 4035. Primary coil bobbin 4025 of coil part 4300 has through-hole 4025A through which columnar bar 4012 of core 4010 penetrates. Secondary windings 4030 are each divided into a plurality of portions and wound to be disposed alternately with insulator films. Secondary coil bobbin 4035 includes terminal block 4038 in which terminal pins 4210 are buried. The low-voltage side ends of secondary windings 4030 are wound around terminal pins 4210 and connected to diodes 4040 held in diode holder 4045. Connection pin 4211 is buried in the vicinity of the high-voltage side ends of secondary coil bobbin 4035.

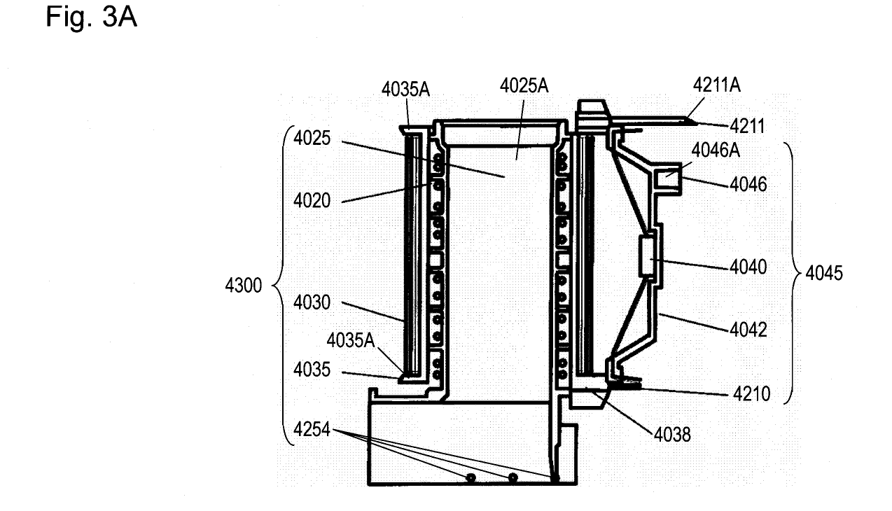

FIG. 4A is a schematic diagram of diode holder 4045, and FIG. 4B is a sectional view of diode holder 4045 taken along line 4B-4B of FIG. 4A. Diode holder 4045 includes holder substrate 4042, a plurality of holder projections 4043 extending from holder substrate 4042, and a plurality of diodes 4040 sandwiched and held between holder projections 4043. Thus, holder substrate 4042 is a member mounted with diodes 4040.

Diodes 4040 include lead wires 4041, which are connected to the start ends and finish ends of the plurality of portions of secondary windings 4030. Core 4010 includes bar 4012 in through-hole 4025A of coil part 4300 (primary coil bobbin 4025), square prism bar 4011 extending in parallel with bar 4012, and bars 4013 and 4014, which are connected to both ends of bars 4011 and 4011, respectively. Bars 4011 to 4014 together form a closed square ring. Diode holder 4045 faces coil part 4300 on the side opposite to bar 4011 of core 4010, so that no portions of core 4010 are located between diode holder 4045 and coil part 4300.

Holder substrate 4042 of diode holder 4045 includes rib 4047 and engaging portion 4048 for fixing secondary coil bobbin 4035, cylindrical portion 4046 having hollow hole 4046A, and square holes 4049.

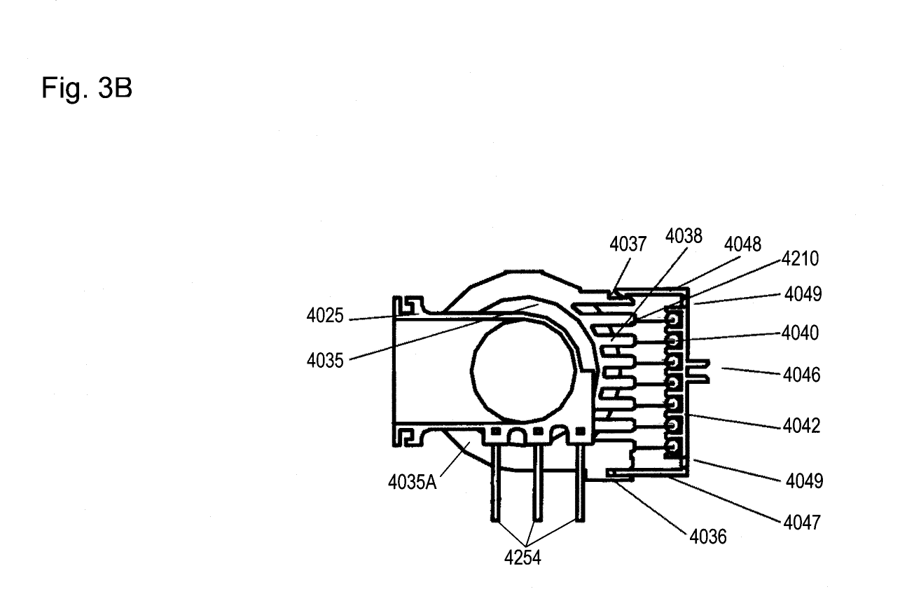

FIGS. 5A, 5B, and 5C are a front view, a rear side view, and a bottom view, respectively, of component block 4100. Component block 4100 includes component substrate 4110, high-voltage capacitors 4050, 4055, ceramic substrate resistors 4060, 4065, high-voltage protection resistors 4070, 4075, other electrical components, and conductive rubber 4230. These are connected to the high-voltage-side finish ends of secondary windings 4030. Ceramic substrate resistors 4060 and 4065 each include a ceramic substrate and a resistive element printed thereon. These components are disposed on both sides of planar component substrate 4110 molded from a plastic material separate from diode holder 4045. Thus, component substrate 4110 is a member mounted with the electrical components.

Component substrate 4110 of component block 4100 is provided on its rear surface with substrate terminal blocks 4142 having terminal pins 4253 buried therein. High-voltage capacitor 4050 includes lead wire 4052, which is connected to one of terminal pins 4253 via notch 4180 of component substrate 4110. Component substrate 4110 is also provided on its rear surface with substrate terminal blocks 4141 having terminal pins 4250 and 4252 buried therein. Ceramic substrate resistor 4060 includes earth lead wire 4061 connected to one of terminal pins 4252. Ceramic substrate resistor 4065 includes earth lead wire 4066 connected to one of terminal pins 4252. The other components are connected to terminal pins 4250. Substrate terminal blocks 4141 and 4142 are aligned with each other and terminal pins 4250, 4252, and 4253 are arranged in a straight line.

As shown in FIGS. 1A and 1B, terminal pins 4250, 4252, and 4253 extend outside from side surface 4241 of substantially rectangular outer case 4240. Outer case 4240 includes opening 4240A through which to insert the transformer body. Opening 4240A of side surface 4241 has notches 4245 formed at end 4242 thereof. Primary coil bobbin 4025 includes terminal pins 4254 to which the finish ends of primary winding 4020 are connected. Terminal pins 4254 extend outside side surface 4241 and are aligned with terminal pins 4250, 4252, and 4253 of component block 4100.

When coil part 4300, diode holder 4045, and component block 4100 are combined together and inserted through opening 4240A of outer case 4240, terminal pins 4250, 4252, 4253, and 4254 are positioned at notches 4245 of outer case 4240.

Each of component block 4100 and diode holder 4045 faces coil part 4300 on the side opposite to bar 4011 of core 4010. Therefore, no portions of core 4010 are located between coil part 4300 and each of component block 100 and diode holder 4045. In addition, terminal pins 4250, 4252, 4253, and 4254 extending from coil part 4300 and component block 4100 are aligned with each other at end 4242 of outer case 4240 and protrude from side surface 4241 of outer case 4240. This structure can reduce the thickness between side surface 4241 of high-voltage transformer 4310 and side surface 4241A on the other side. When high-voltage transformer 4310 is mounted on a thin device such as a flat-screen TV, side surface 4241 comes into contact with the printed-circuit board of the device, thus facilitating the insertion of terminal pins 4250, 4252, 4253, and 4254 into the holes of the printed-circuit board. This reduces the height of the high-voltage transformer from the printed-circuit board, thereby reducing the depth of the device.

FIG. 4A is a schematic diagram of diode holder 4045, and FIG. 4B is a sectional view of diode holder 4045 taken along line 4B-4B of FIG. 4A. Diode holder 4045 for holding diodes 4040 is made of resin. Diode holder 4045 includes holder substrate 4042, holder projections 4043 extending at regular intervals from holder substrate 4042, rib 4047 extending from holder substrate 4042, and engaging portion 4048, which extends from holder substrate 4042 and has engaging claw 4048A at its tip. Holder projections 4043 sandwich and hold diodes 4040 with an insulation distance therebetween. Rib 4047 positions diode holder 4045 (holder substrate 4042) with respect to secondary coil bobbin 4035.

As shown in FIG. 3B, secondary coil bobbin 4035 includes flanges 4035A each having recess 4036 and engaging portion 4037. Rib 4047 extending from holder substrate 4042 is inserted into recess 4036 of secondary coil bobbin 4035. Engaging portion 4048 of diode holder 4045 and engaging portion 4037 of secondary coil bobbin 4035 are engaged with each other so as to fix diode holder 4045 to secondary coil bobbin 4035.

Secondary coil bobbin 4035 includes terminal block 4038 having terminal pins 4210 buried therein, to which the winding-start ends and winding-finish ends of secondary windings 4030 are fixed. Terminal pins 4210 are connected to lead wires 4041 of diodes 4040.

As shown in FIGS. 5A to 5C, in component block 4100, planer component substrate 4110 molded from a plastic material is provided on both sides thereof with ceramic substrate resistors 4060, 4065, high-voltage capacitors 4050, 4055, and other electronic components. Component block 4100 is substantially rectangular from a two dimensional view. High-voltage capacitors 4050 and 4055 are mounted on component substrate 4110 via engaging portions 4135 having engaging claws at their tips. Ceramic substrate resistors 4060 and 4065 are mounted on component substrate 4110 via engaging portions 4143 and 4146, respectively. Substrate 4110 is provided with projection 4150 and rib 4151 having an engaging portion at its tip. Rib 4151 is L-shaped.

In component block 4100, component substrate 4110 is provided in the vicinity of the center of a side surface thereof with projection 4150 and rib 4151, which face each other and extend in the same direction. Rib 4151 is provided at both ends thereof with outwardly L-shaped tip engaging portions 4152.

Holder substrate 4042 includes integrally molded cylindrical portion 4046 in the vicinity of the center of the surface opposite to the surface on which diodes 4040 are mounted. Square holes 4049 are formed near both ends of the surface on which diodes 4040 are mounted.

As shown in FIGS. 1A and 1B, projection 4150 in the vicinity of the center of the side surface of component substrate 4110 of component block 4100 is fitted into hollow hole 4046A of cylindrical portion 4046 of diode holder 4045. Engaging portions 4152 of component substrate 4110 are inserted and fixed into square holes 4049 near both ends of the surface of holder substrate 4042 of diode holder 4045. Thus, diodes 4040 mounted on holder substrate 4042, and high-voltage capacitors 4050, 4055 and ceramic substrate resistors 4060, 4065 mounted on component substrate 4110 are fixed to each other.

Secondary coil bobbin 4035 is fitted around primary coil bobbin 4025. Diode holder 4045 is attached to secondary windings 4030, and component block 4100 is attached to secondary windings 4030. Between primary coil bobbin 4025 and component block 4100 are disposed secondary coil bobbin 4035 and diode holder 4045. Component block 4100 and diode holder 4045 are fixedly positioned by their engaging portions. Therefore, the insulation distance between component block 4100 and the inner wall of outer case 4240 is maintained at a predetermined value even if there are dimensional variations of the moldings or dimensional variations due to mold distortion.

As shown in FIGS. 1A and 1B, component substrate 4110 of component block 4100 is provided at an end surface thereof with rib 4112 for positioning. Rib 4112 for positioning is inserted into groove 4243 on the side surface of outer case 4240 so as to fix component block 4100. This ensures the fixing of diode holder 4045 and component block 4100 in outer case 4240.

As shown in FIG. 2, terminal block 4038 disposed in secondary coil bobbin 4035 includes connection pin 4211 having acute tip 4211A. Lead wire 4041 of diode 4040 having the highest voltage among the plurality of diodes 4040 mounted on holder substrate 4042 is arranged to be substantially parallel to connection pin 4211 buried in terminal block 4038.

Component substrate 4110 is mounted with substantially columnar conductive rubber 4230 having side surface 4230A with a dish-shaped recess. Lead wires 4041 of diodes 4040 and connection pin 4211 of secondary coil bobbin 4035 are electrically connected to each other by soldering. When component block 4100 is combined with diode holder 4045 attached to secondary coil bobbin 4035, connection pin 4211 of secondary coil bobbin 4035 pierces into conductive rubber 4230 of component block 4100 so as to be electrically connected to conductive rubber 4230.

Side surface 4230A of conductive rubber 4230 is provided with dish-shaped recess 4232 facing coil part 4300. This facilitates the piercing of connection pin 4211 into conductive rubber 4230 even if tip 4211A of connection pin 4211 of secondary coil bobbin 4035 varies in size. The dish-shaped recess on the columnar side surface of conductive rubber 4230 can be easily formed, allowing a reduction in the cost of the mold and the components. Component block 4100 includes frame 4131 for holding conductive rubber 4230 and engaging portion 4132. Engaging portion 4132 makes conductive rubber 4230 fitted into frame 4131 less likely to become detached therefrom.

When tip 4211A of connection pin 4211 of secondary coil bobbin 4035 varies little in size, there is no need for conductive rubber 4230 to have the dish-shaped recess, allowing a further reduction in the cost of the mold of conductive rubber 4230 and the cost of the components.

The above-described structure ensures the insulation distance between component block 4100 and outer case 4240, thus preventing the high-voltage components in component block 4100 from being in contact with outer case 4240. The space between the high-voltage components in component block 4100 and outer case 4240 is filled with epoxy resin for insulation. The insulation distance between component block 4100 and outer case 4240 varies little enough to make case 4240 thin.

Diode holder 4045 holding diodes 4040 and component block 4100 including high-voltage components such as high-voltage capacitors are separate members. Therefore, it can be visually recognized whether diode holder 4045 has been connected to component block 4100 or not. Conductive rubber 4230 facilitates the connection between coil part 4300 and component block 4100, allowing a reduction in the cost of the mold and the components.

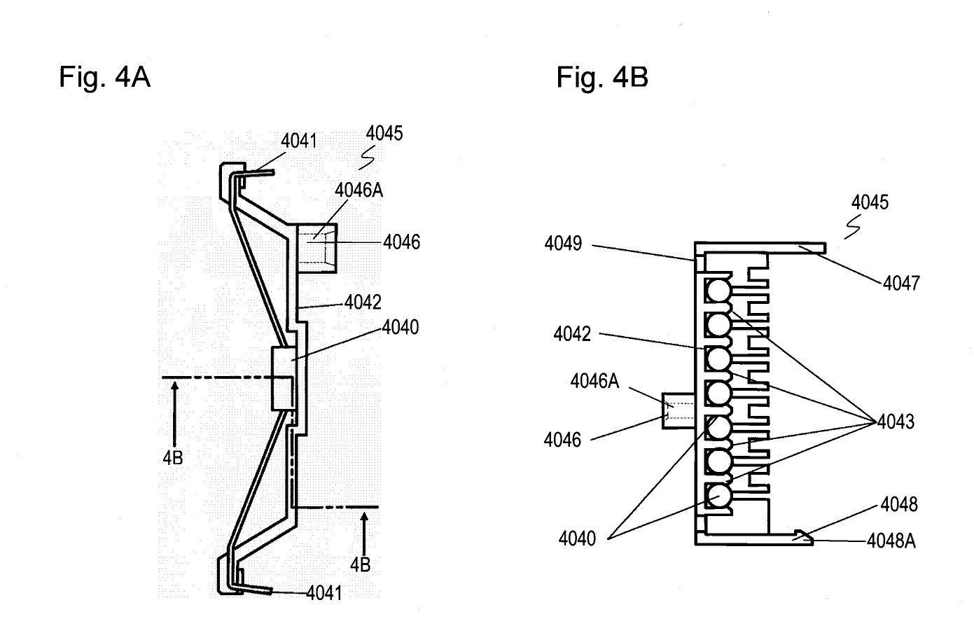

FIG. 6 is a circuit diagram of high-voltage transformer 4310.

Coil part 4300 includes core 4010, primary winding 4020, and secondary windings 4030. Diode holder 4045 includes diodes 4040. Component block 4100 includes high-voltage capacitors 4050, 4055, high-voltage protection resistors 4070, 4075, and ceramic substrate resistors 4060, 4065.

High-voltage protection resistors 4070 and 4075 having a high resistance of 5 kg to 20 kg generate high heat when high-voltage transformer 4310 is supplied with a large current of 5 mA to 15 mA. The heat may affect the components in component block 4100, diodes 4040 in diode holder 4045, and primary and secondary windings 4020, 4030 in coil part 4300. To disperse the heat, two series-connected high-voltage protection resistors 4070 and 4075 are used. The heat may be further dispersed by using two or more high-voltage protection resistors. For example, it is possible to use two sets of two parallel-connected high-voltage protection resistors, that is, a total of four high-voltage protection resistors.

In component block 4100, planar component substrate 4110 molded from plastic includes the components on both sides thereof. More specifically, in component substrate 4110, high-voltage protection resistors 4070 and 4075 are mounted on the upper part of both sides thereof, respectively. Ceramic substrate resistors 4060 and 4065 are mounted at the center of one side. High-voltage capacitors 4050 and 4055 are mounted in the middle of both sides thereof, respectively. Ceramic substrate resistors 4969, 4965, terminal pins 4250, 4252, and 4253 to be connected to the earth sides of the high-voltage capacitors, and substrate terminal blocks 4141, 4142 are disposed at the bottom part thereof.

Component substrate 4110 of component block 4100 is provided at the upper part of both sides thereof with solder joints 4121, 4122, 4123, 4124, 4125, and 4126, which are each formed by notching a part of a hollow cylinder in order to connect the electronic components by soldering. Solder joints 4122 and 4123 are connected by soldering to the lead wires of high-voltage protection resistors 4070 and 4075. Solder joints 4125 and 4126 are connected by soldering to the lead wires. High-voltage protection resistor 4070 is connected to output cable 4260 of high-voltage transformer 4310 from the high-voltage finish ends of coil part 4300 via conductive rubber 4230, solder joint 4121, high-voltage protection resistor 4070, and solder joints 4122, 4123, and 4124. Ceramic substrate resistor 4065 is connected to high-voltage protection resistor 4075 and output cable 4260 via solder joint 4124.

High-voltage capacitor 4050 is connected via solder joints 4121 and 4126. High-voltage capacitor 4055 and ceramic substrate resistor 4060 are connected from the high-voltage finish ends of coil part 4300 via conductive rubber 4230 and solder joints 4121, 4125, and 4126.

Engaging portions 4135, 4143, and 4146 are provided to secure, to position, and to fix the insulation distance between high-voltage protection resistors 4070, 4075, high-voltage capacitors 4050, 4055, ceramic substrate resistors 4060, 4065 and the other components.

As shown FIGS. 5A and 5B, high-voltage protection resistors 4070 and 4075 at the upper part of component block 4100 are mounted on both sides, respectively, of substrate 4110. High-voltage protection resistors 4070, 4075 and substrate 4110 are combined together to be substantially rectangular from a two dimensional view. As a result, they can be easily housed in substantially rectangular protruding part 4244 protruding from the top panel of outer case 4240

When supplied with a large current, high-voltage protection resistors 4070 and 4075 generate high heat. High-voltage protection resistors 4070 and 4075, however, can be disposed away from coil part 4300 and diode holder 4045, allowing a reduction in the thickness of high-voltage transformer 4310.

The present invention is applicable to a transformer in which the electrical components in component block 4100 have a different circuit and a different design from in the transformer according to the present embodiment.

### Second Embodiment

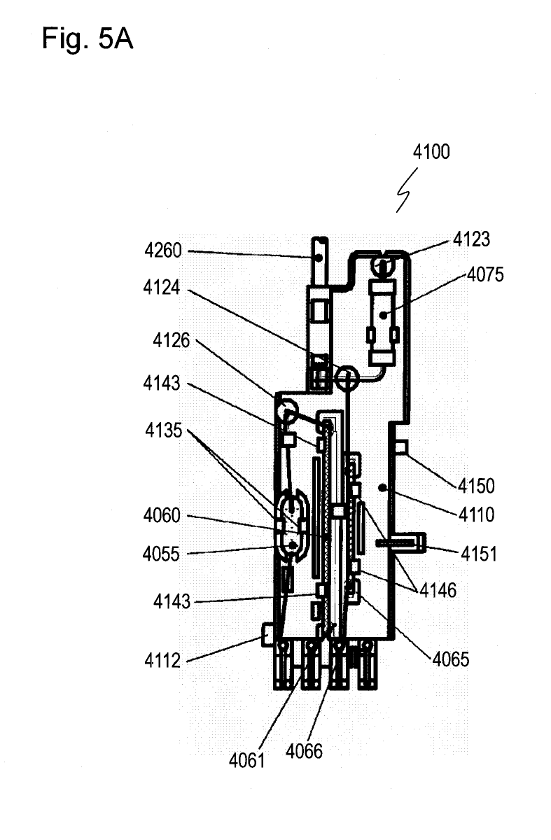

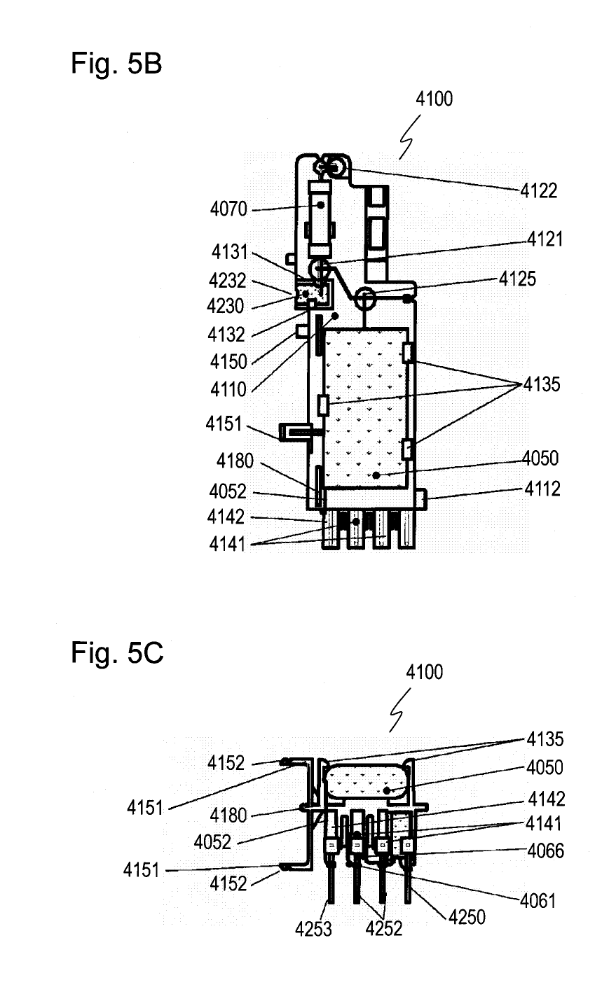

FIG. 7 is a sectional view of high-voltage transformer 7301 of a second embodiment of the present invention. FIG. 8 is a sectional view of high-voltage transformer 7301 taken along line 8-8 and seen in direction 7301A of FIG. 7

High-voltage transformer 7301 includes coil part 3300, diode holder 3045, and component block 3100, which are combined together and housed in substantially rectangular outer case 3240. Outer case 3240, which is molded from plastic resin, is filled with insulating resin 3260 such as epoxy resin. As shown in FIG. 7, coil part 3300, diode holder 3045, and component block 3100 are arranged in a straight line in direction 7301C in this order and together form a transformer body.

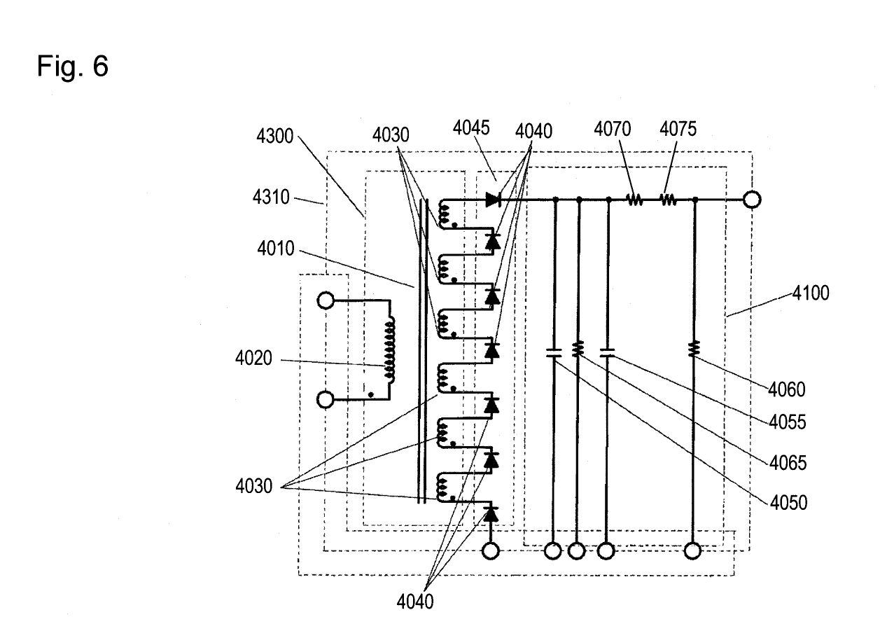

FIG. 9 is a circuit diagram of high-voltage transformer 7301. High-voltage transformer 7301 includes coil part 3300, diode holder 3045, and component block 3100, which are housed in outer case 3240.

The following is a description of coil part 3300, which includes core 3010, primary coil bobbin 3025 fitted around the shaft of core 3010, primary winding 3020 wound around primary coil bobbin 3025, secondary coil bobbin 3035 fitted around the outer periphery of primary coil bobbin 3025, and secondary windings 3030 wound around secondary coil bobbin 3035. Secondary windings 3030 are divided into a plurality of portions and wound to be disposed alternately with insulator films. Primary and secondary windings 3020 and 3030 have low-voltage ends 3030B, which are connected to terminal pins 3254.

Diode holder 3045 holds a plurality of diodes 3040, which are connected to the start ends and finish ends of the plurality of portions of secondary windings 3030. Core 3010 has leg 3011 extending from coil part 3300 in the direction opposite to diode holder 3045. Therefore, no portions of core 3010 are located between secondary coil bobbin 3035 of coil part 3300 and diode holder 3045.

The following is a description of component block 3100. A high voltage occurs at finish ends 3030A of secondary windings 3030. Finish ends 3030A are connected to ceramic substrate resistors 3060, 3065, high-voltage capacitors 3050, 3055, and high-voltage protection resistors 3070, 3075. Ceramic substrate resistors 3060 and 3065 each include a ceramic substrate and a resistive element printed thereon. Ceramic substrate resistors 3060, 3065, high-voltage capacitors 3050, 3055, and high-voltage protection resistors 3070, 3075 are held by component holder 3100A, which is separate from diode holder 3045. Component holder 3100A includes planar substrate 3100B and a plurality of engaging portions 3100C extending from both sides of substrate 3110B. They are molded from a plastic material. Engaging portions 3100C are arranged in accordance with the sizes of the components such as ceramic substrate resistor 3060 and high-voltage capacitor 3050 so as to be engaged therewith.

Component block 3100 is provided on its rear side with terminal blocks 3141 in which terminal pins 3250, 3252, and 3253, respectively, are buried. High-voltage capacitor 3050 has lead wire 3052, which is connected to one of terminal pins 3253 via notch 3180. Ceramic substrate resistor 3060 has earth lead wire 3061, which is connected to one of terminal pins 3252. Ceramic substrate resistor 3065 has earth lead wire 3066, which is connected to one of terminal pins 3252. The other components are connected to terminal pins 3250. Terminal blocks 3141 are aligned with each other, and terminal pins 3250, 3252, and 3253 are aligned with each other.

Terminal pins 3250, 3252, and 3253 of component block 3100 extend from component holder 3100A through side surface 3241 and protrude outside outer case 3240. Terminal pins 3254 of coil part 3300 extend from coil part 3300 through side surface 3241 and protrude outside outer case 3240. Side surface 3241 has end 3242, which faces opening 3240A of outer case 3240 and includes a plurality of notches 3243. When coil part 3300, diode holder 3045, and component block 3100 are combined together and inserted into outer case 3240 through opening 3240A, terminal pins 3250, 3252, 3253, and 3254 are positioned in notches 3243.

Terminal pins 3250, 3252, 3253, and 3254 are inserted into holes 7301E of printed-circuit board 7301D of the display device. Printed-circuit board 7301D includes surface 7301F, on which side surface 3241 of outer case 3240 is mounted. Printed-circuit board 7301D has surface 7301G opposite to surface 7301F. Surface 7301G has holes 7301E surrounded with conductive pattern 7301H made of copper foil. Terminal pins 3250, 3252, 3253, and 3254 are electrically connected to conductive pattern 7301H by soldering or the like.

Secondary coil bobbin 3035 includes hollow cylindrical part 3035B, and flanges 3035A formed on both ends, respectively, of cylindrical part 3035B. Flanges 3035A are shaped like disks whose centers are on center line 3301 of coil part 3300. This makes distances LA1 and LA2 between the center line of coil part 3300 and both ends, respectively, of each of flanges 3035A are equal to each other. Substantially rectangular outer case 3240 has side surface 3246 opposite to side surface 3241. Side surfaces 3241 and 3246 are away from center line 3301 of coil part 3300 by distances LC1 and LC2, respectively. Side surface 3241 and 3246 are away from flanges 3035A of secondary coil bobbin 3035 by distances LB1 and LB2, respectively.

In high-voltage transformer 7301, distance LB1 is larger than distance LB2, and distance LC1 is larger than distance LC2. More specifically, the distance between side surface 3241 and coil part 3300 subjected to a high voltage is set larger than the distance between side surface 3246 and coil part 3300 because side surface 3241 is closer to conductive pattern 7301H of printed-circuit board 7301D than side surface 3246 is. This ensures a large insulation distance between conductive pattern 7301H on printed-circuit board 7301D and the electrical components on printed-circuit board 7301D, and coil part 3300.

Thus, coil bobbin 3035 has center line 3301 around which the windings are wound. Outer case 3240 includes side surfaces 3241 and 3246 which are facing each other and parallel to center line 3301. Side surface 3246 of outer case 3240 is in contact with board 7301D. Distance LC1 between center line 3301 and side surface 3241 of outer case 3240 is larger than distance LC2 between the center line and side surface 3246 of outer case 3240.

Side surface 3246, which is not in contact with printed-circuit board 7301D, is away from the peripheral components by 10 mm to 15 mm, thereby ensuring a sufficient insulation distance between coil part 3300 and the components included therein.

The above-described structure ensures a sufficient insulation distance up to conductive pattern 7301H and the components on printed-circuit board 7301D of the display device, thus achieving thin high-voltage transformer 7301.

The circuit of high-voltage transformer 7301 can be other than the circuit of FIG. 9. The same effect can be provided by a high-voltage transformer in which the circuit of component block 3100 is different from in high-voltage transformer 7301. Furthermore, high-voltage transformer 7301 according to the second embodiment is applicable to high-voltage transformer 4310 of FIGS. 1A and 1B to provide the same effect.

### Third Embodiment

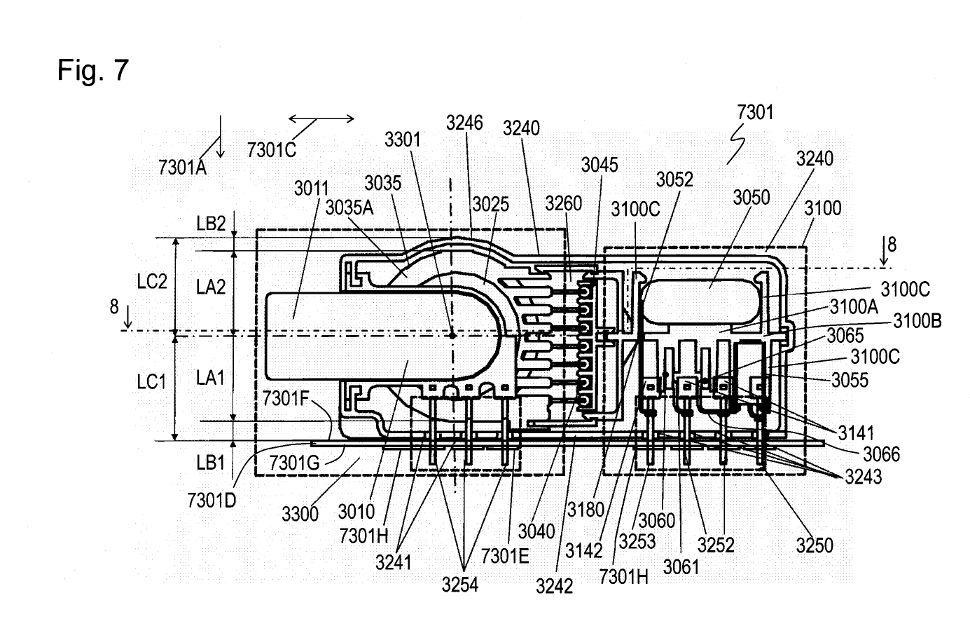

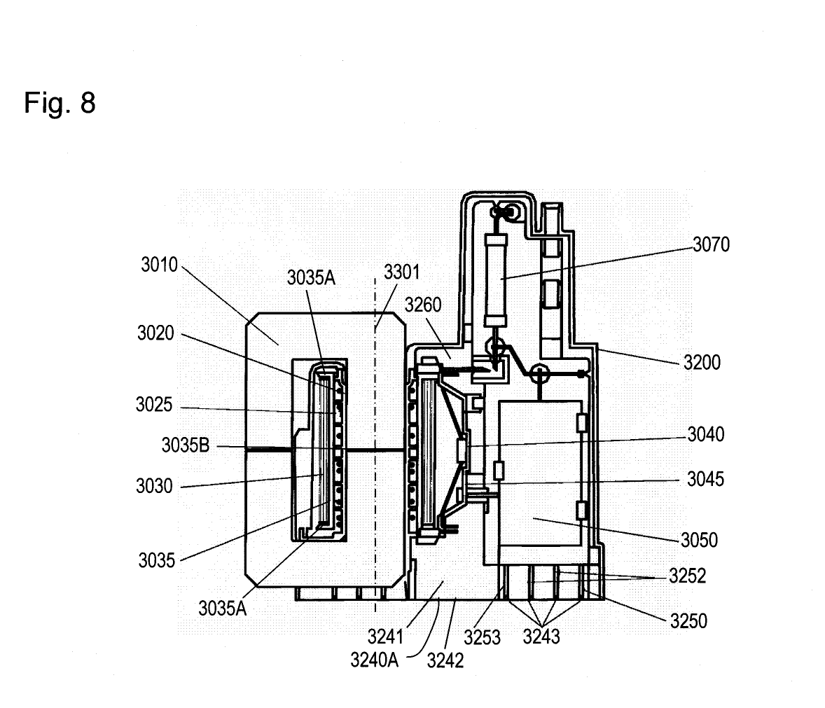

FIG. 10 is a sectional view of high-voltage transformer 7501 according to a third embodiment of the present invention. FIGS. 11A and 11B are a front view and a bottom view, respectively, of primary coil bobbin 5001.

High-voltage transformer 7501 includes core 5031 made of ferrite, primary coil bobbin 5001, terminal pins 5003, primary winding 5004, outer case 5008, and insulating resin 5013. Insulating resin 5013 is made of thermosetting resin such as epoxy resin and hardened. Primary coil bobbin 5001, some of terminal pins 5003, and primary winding 5004 are housed in outer case 5008, which is filled with insulating resin 5013. Primary coil bobbin 5001 includes cylindrical part 5001A into which core 5031 is inserted and pin holders 5002 for holding terminal pins 5003. Terminal pins 5003 are made of metal and square bracket-shaped. Square bracket-shaped terminal pins 5003 each include linear central region 5017 and linear ends 5005, 5006 extending from ends 5017A and 5017B, respectively, of central region 5017 in the same direction at right angles to central region 5017. End 5005 includes winding portion 5005A around which end 5007 of primary winding 5004 is wound. The tip of end 5006 is inserted into printed-circuit board 5009, so that high-voltage transformer 7501 is attached to printed-circuit board 5009. Cylindrical part 5001A of primary coil bobbin 5001 and core 5031 are concentrically arranged with respect to center line 5010. Primary coil bobbin 5001 has longitudinal direction 5001B parallel to center line 5010. High-voltage transformer 7501 has height 5016 from printed-circuit board 5009.

Pin holders 5002 hold central regions 5017 of terminal pins 5003 in such a manner that ends 5005 and 5006 extend from central regions 5017 in a direction away from center line 5010 of primary coil bobbin 5001.

Ends 5006 of terminal pins 5003 are designed to be inserted into printed-circuit board 5009. Ends 5007 of primary winding 5004 are wound around winding portions 5005A of ends 5005. Ends 5005 are not inserted into printed-circuit board 5009, thus allowing the length of winding portions 5005A to be the shortest possible to wind ends 5007 of primary winding 5004 therearound.

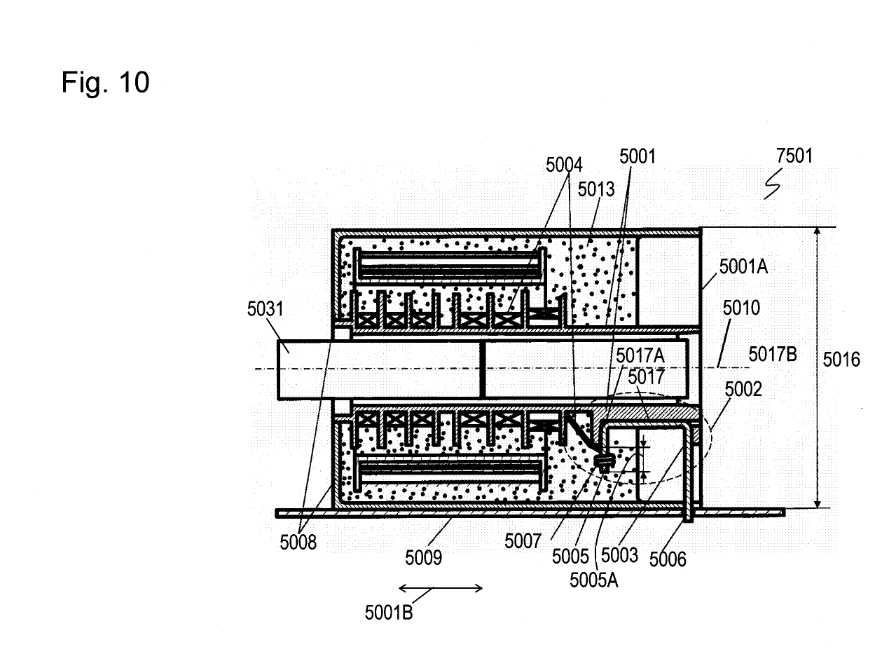

FIG. 13 is a schematic diagram showing the soldering of ends 5007 of primary winding 5004 to winding portions 5005A of ends 5005 of terminal pins 5003. Winding portions 5005A around which ends 5007 are wound are soaked in molten solder 5012 in solder bath 5011 so as to solder ends 5007 to winding portions 5005A. Since winding portions 5005A can be set to the shortest possible length to wind ends 5007 of primary winding 5004 therearound, the length of ends 5006 of terminal pins 5003 to be soaked in molten solder 5012 can be reduced. As a result, the heat transmitted from molten solder 5012 to pin holders 5002 via terminal pins 5003 can be reduced to prevent heat deflection of pin holders 5002 and to reduce the time period of soaking winding portions 5005A.

As shown in FIG. 11A, pin holders 5002 of primary coil bobbin 5001 hold terminal pins 5003 in such a manner that central regions 5017 of square bracket-shaped terminal pins 5003 are arranged in parallel with each other, and that ends 5005 and 5006 are away from center line 5010 in the same direction. Ends 5006 of terminal pins 5003 are taken out in the same direction. As shown in FIG. 10, this allows center line 5010, that is, the longitudinal direction of primary coil bobbin 5001 can be in parallel with printed-circuit board 5009 when high-voltage transformer 7501 is mounted thereon.

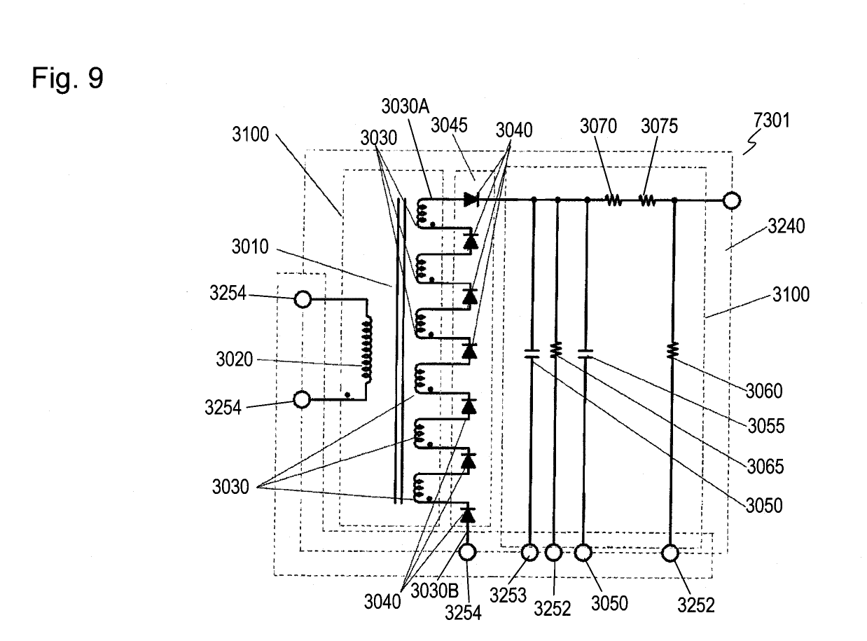

Height 5016 of high-voltage transformer 7501 from printed-circuit board 5009 can be far shorter than the height of conventional high-voltage transformers because height 5016 corresponds to the horizontal thickness of high-voltage transformer 7501. FIG. 12 is a configuration diagram of flat-screen TV 7501A having high-voltage transformer 7501 built therein. High-voltage transformer 7501 has a short depth with respect to display device 5080 of flat-screen TV 7501A.

As shown in FIG. 11A, ends 5005 of terminal pins 5003 extending in the same direction can be soaked in molten solder 5012 all together.

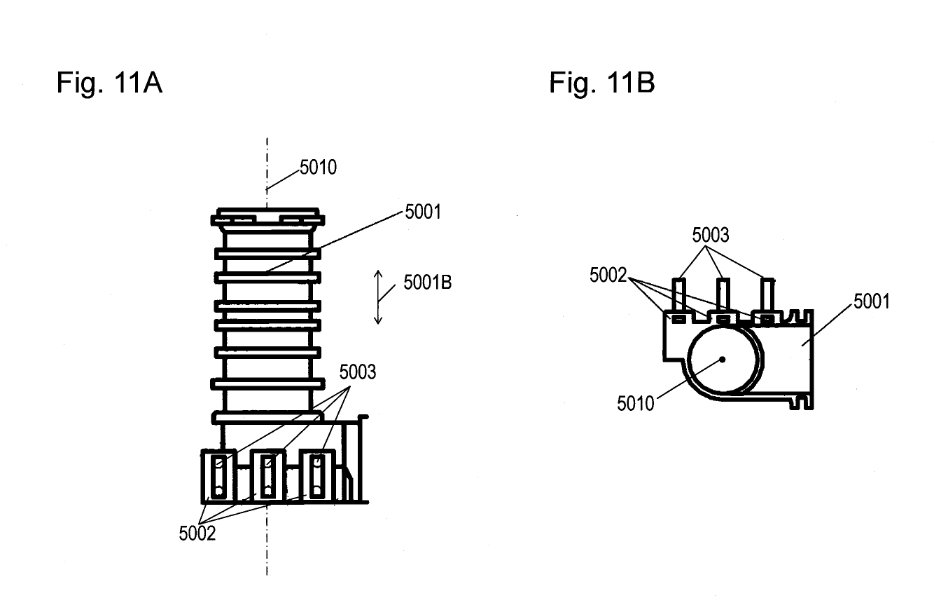

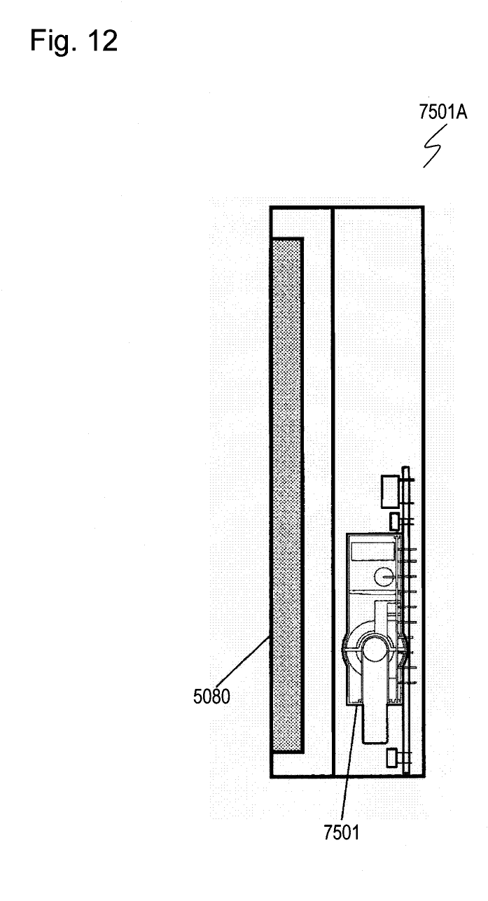

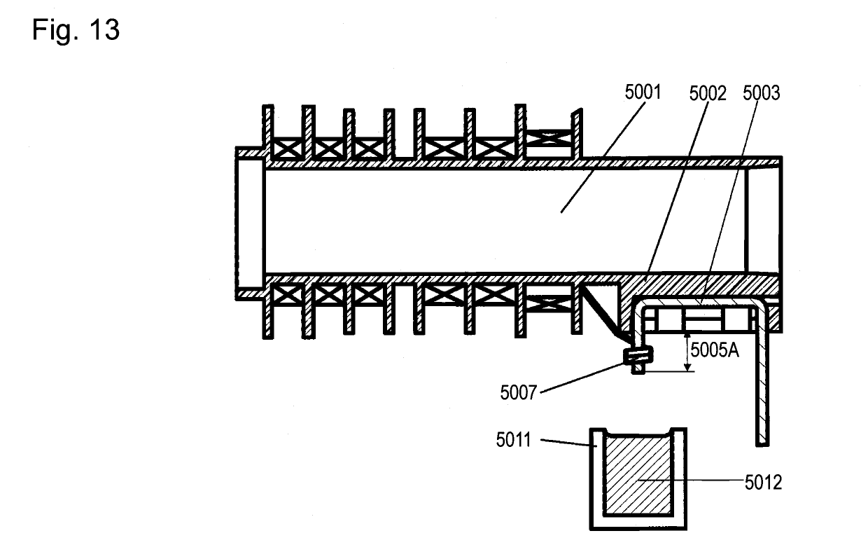

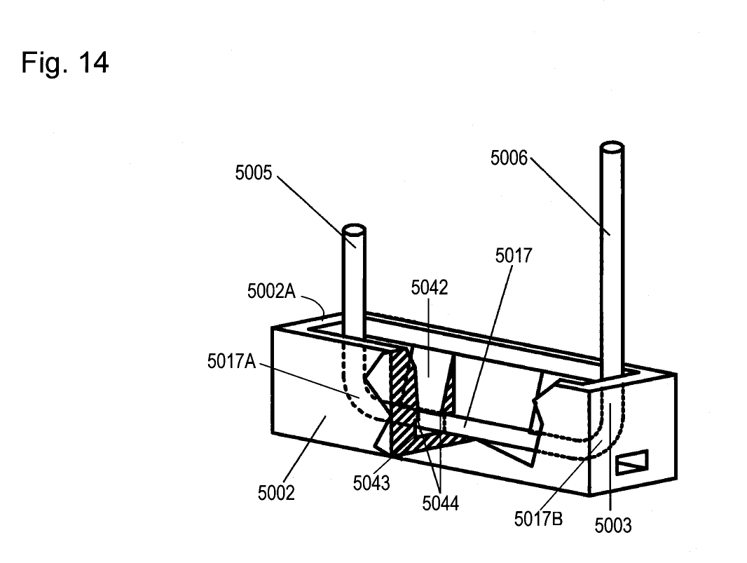

FIG. 14 is a perspective view of pin holder 5002 in the state of holding terminal pin 5003. FIG. 15 is a front view of pin holder 5002. FIG. 16 is a sectional view of pin holder 5002 taken along line 16-16 of FIG. 15 in the state of holding terminal pin 5003. FIG. 17A is a sectional view of pin holder 5002 taken along line 17A-17A of FIG. 15. FIG. 17B is a sectional view of pin holder 5002 taken along line 17A-17A of FIG. 15 in the state of holding terminal pin 5003.

Pin holders 5002 each include groove 5042 having opening 5043T open to front face 5002A, and groove 5043 connected to bottom 5042A of groove 5042. Groove 5042 has a substantially trapezoidal cross section whose width narrows from front face 5002A to bottom 5042A. Groove 5043 has a rectangular cross section. Grooves 5042 and 5043 are formed along central regions 5017 of terminal pins 5003. Pin holders 5002 each include projections 5044 extending from bottom 5042A of groove 5042. More specifically, groove 5043 has width 5043W larger than width 5042W of bottom 5042A of groove 5042. Projections 5044 fix terminal pins 5003 in such a manner that central regions 5017 of terminal pins 5003 can be housed in groove 5043. Central regions 5017 of terminal pins 5003 are in contact with projections 5044 and bottom 5044D of groove 5043 so as to be stably fixed at three points: projections 5044 and bottom 5044D in groove 5043. This prevents terminal pins 5003 from being detached from grooves 5042 and 5043.

As shown in FIG. 16, pin holders 5002 each include holding ribs 5046U and 5046D for sandwiching grooves 5042 and 5044 therebetween. Terminal pins 5003 are fixed between holding ribs 5046U and 5046D. Ends 5006 of terminal pins 5003 are longer than ends 5005, allowing ends 5006 of terminal pins 5003 to be protruded from one side surface of high-voltage transformer 7501 without being hindered by ends 5005. As a result, as shown in FIG. 10, ends 5006 can be smoothly inserted into the holes of printed-circuit board 5009 when high-voltage transformer 7501 is mounted on printed-circuit board 5009.

As shown in FIG. 10, outer case 5008 houses ends 5005 of terminal pins 5003 having winding portions 5005A around which ends 5007 of primary winding 5004 are wound. Therefore, ends 5005 are tightly fixed together with winding portions 5005A to insulating resin 5013, which is poured into outer case 5008 and hardened. This structure reduces vibrations or forces applied to terminal pins 5003 from outside high-voltage transformer 7501, thereby preventing breakage of primary winding 5004. This structure also reduces impacts due to vibration or dropping after high-voltage transformer 7501 is mounted on the printed-circuit board, thereby preventing the occurrence of solder cracks in the soldered printed-circuit board. When high-voltage transformer is mounted on printed-circuit board 5009, the longitudinal direction of primary coil bobbin 5001 can be made parallel to the surface of printed-circuit board 5009. This greatly reduces the height of high-voltage transformer 7501 from printed-circuit board 5009.

As shown in FIGS. 17A and 17B, width 5043W of the rectangular cross section of groove 5043 is not less than diameter 5003L of terminal pins 5003, and height 5043H is smaller than diameter 5003L of terminal pins 5003. Width 5042W of bottom 5042A of groove 5042 connected to groove 5043 is smaller than diameter 5003L of terminal pins 5003. Opening 5043T of groove 5043 open to front face 5002A has width 5043S, which is larger than diameter 5003L of terminal pins 5003. In other words, groove 5042 has a trapezoidal cross section including an upper base corresponding to width 5043S of opening 5043T and a lower base corresponding to bottom 5043A of width 5043W. Groove 5042 is connected at its bottom 5042A to groove 5043.

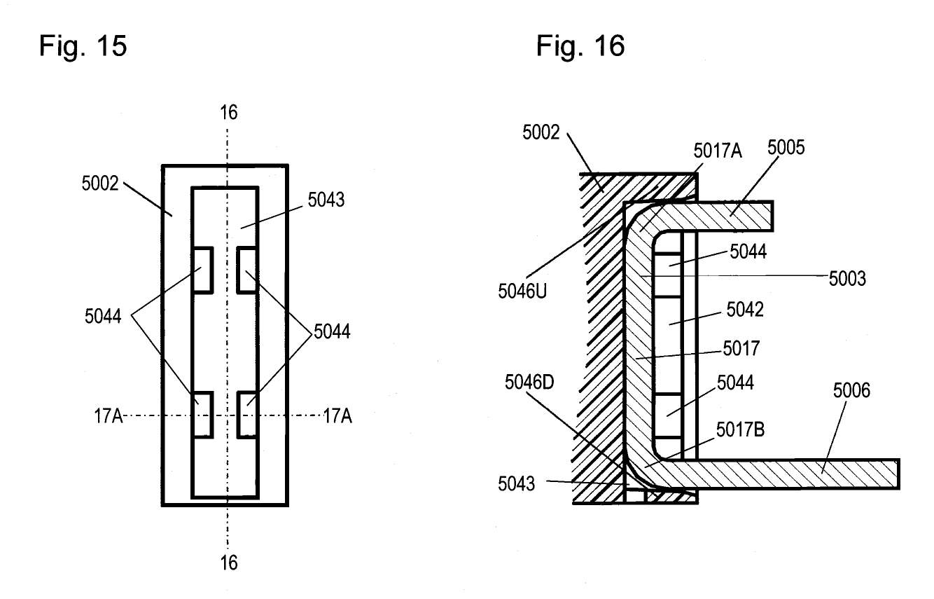

FIG. 18A is a sectional view of another type of pin holder 5102 of the third embodiment. FIG. 18B is a sectional view of pin holder 5102 in the state of holding terminal pin 5003. In FIGS. 18A and 18B, like components are labeled with like reference numerals with respect to FIGS. 14 to 17B, and the description thereof will be omitted.

Pin holders 5102 each include groove 5047 having an elliptic arc cross section instead of groove 5043 having the rectangular cross section of FIG. 17A. Pin holders 5102 each further include projections 5044L and 5044R instead of projections 5044 of FIG. 17A. In other words, groove 5047 is connected to bottom 5042A of groove 5042 having the trapezoidal cross section. The elliptic arc cross section of groove 5047 has short diameter 5047T parallel to the depth direction of groove 5042 and smaller than diameter 5003L of terminal pins 5003, and long diameter 5047W larger than diameter 5003L.

Terminal pins 5003 are in contact with projections 5044L, 5044R, and bottom 5044E of groove 5047. Pin holders 5102 each stably hold terminal pin 5003 in groove 5047 at three points: projections 5044L, 5044R, and bottom 5044E of groove 5047, thereby preventing terminal pin 5003 from being displaced or detached from groove 5047.

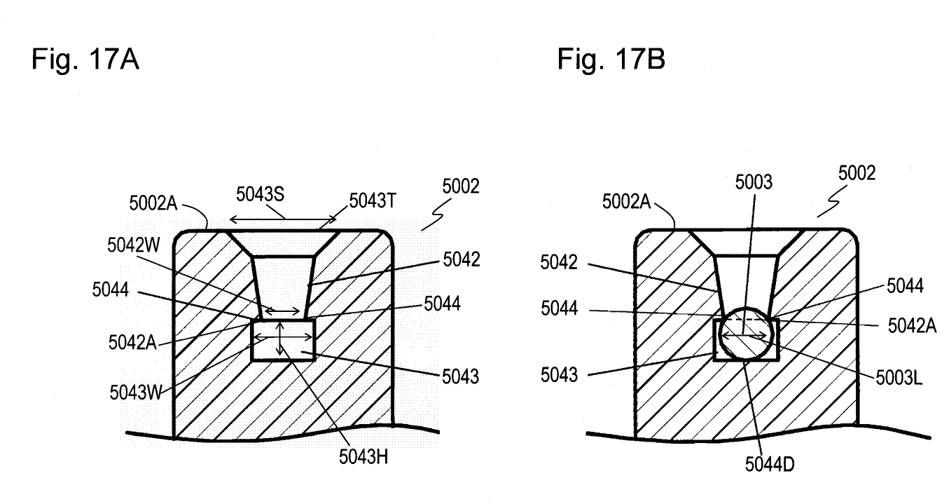

FIG. 19A is a sectional view of further another type of pin holder 5202 of the third embodiment. FIG. 19B is a sectional view of pin holder 5202 in the state of holding terminal pin 5003. In FIGS. 19A and 19B, like components are labeled with like reference numerals with respect to FIGS. 14 to 17B, and the description thereof will be omitted.

Pin holders 5202 each include groove 5048 having a circular arc cross section instead of groove 5043 having the rectangular cross section of FIG. 17A. Pin holders 5202 each further include projections 5044P, 5044Q instead of projections 5044 of FIG. 17A. In other words, groove 5048 is connected to bottom 5042A of groove 5042 having the trapezoidal cross section. The circular arc cross section of groove 5048 has diameter 5048W, which is substantially the same as diameter 5003L of terminal pins 5003.

Terminal pins 5003 are in contact with projections 5044P, 5044Q and bottom 5044F of groove 5048. Pin holders 5202 each stably hold terminal pin 5003 in groove 5048 at three points: projections 5044P, 5044Q and inner periphery 5048F (bottom 5044F) of groove 5048, thereby preventing terminal pins 5003 from being displaced or detached from groove 5048.

### Fourth Embodiment

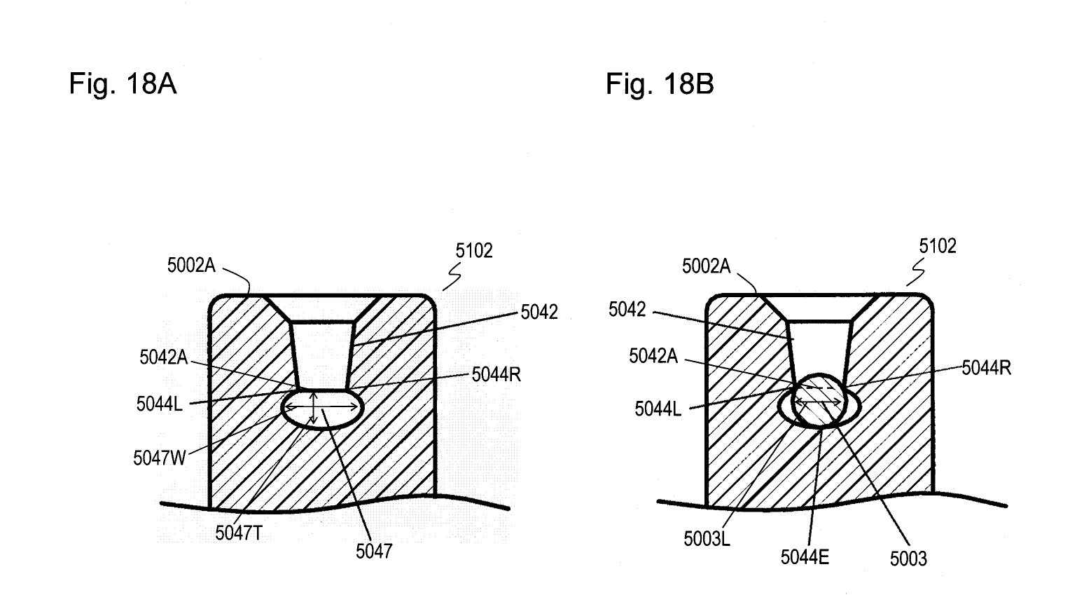

FIG. 20A is a front view of pin holder 5302 of a high-voltage transformer according to a fourth embodiment of the present invention. FIG. 20B is a sectional view of pin holder 5302 taken along line 20B-20B of FIG. 20A. FIG. 20C is a sectional view of pin holder 5302 in the state of holding terminal pin 5003. FIG. 20D is a sectional view of pin holder 5302 taken along line 20D-20D of FIG. 20A. In FIGS. 20A to 20D, like components are labeled with like reference numerals with respect to FIGS. 10 to 13 showing high-voltage transformer 7501, and the description thereof will be omitted.

The high-voltage transformer according to the fourth embodiment includes pin holders 5302 instead of pin holders 5002 of high-voltage transformer 7501 according to the third embodiment. Pin holders 5302 each include pin holding ribs 5302L and 5302R extending from front face 5302A, and pin holding projection 5302B. Pin holding projection 5302B is disposed between pin holding ribs 5302L and 5302R, and face each other with central regions 5017 of terminal pins 5003 and pin holding projection 5302B disposed therebetween.

Pin holding ribs 5302L and 5302R have tips 5351L and 5351R arranged at a spacing larger than diameter 5003L of terminal pins 5003. Pin holding ribs 5302L and 5302R further have surfaces 5350L and 5350R extending from tips 5351L and 5351R and facing each other. The spacing between surfaces 5350L and 5350R decreases as approaching from tips 5351L and 5351R to front face 5302A, that is, central regions 5017 of terminal pins 5003. Pin holding ribs 5302L and 5302R further have surfaces 5345L and 5345R extending from surfaces 5350L and 5350R. Surfaces 5345L and 5345R are parallel to each other and whose spacing is smaller than diameter 5003L. Surfaces 5345L and 5345R have edges 5344L and 5344R in contact with central regions 5017 of terminal pins 5003. Pin holding ribs 5302L and 5302R further have surfaces 5346L and 5346R extending from edges 5344L and 5344R toward front face 5302A and facing each other at a spacing larger than diameter 5003L. Pin holding ribs 5302L and 5302R further have surfaces 5347L and 5347R extending from surfaces 5346L and 5346R toward front face 5302A and facing each other at a spacing larger than the spacing between surfaces 5346L and 5346R.

Pin holding projection 5302B has upper surface 5344G in contact with central regions 5017 of terminal pins 5003. Edges 5344L and 5344R of pin holding ribs 5302L and 5302R and upper surface 5344G of pin holding projection 5302B are in contact with central regions 5017 of terminal pins 5003, thereby fixing terminal pins 5003. As a result, terminal pins 5003 are prevented from being displaced or detached from pin holders 5302. This facilitates the mounting of the high-voltage transformer according to the fourth embodiment onto the printed-circuit board.

As shown in FIG. 20D, pin holders 5302 each include holding ribs 5346U and 5346D extending from front face 5302A and being arranged in a direction in which central regions 5017 of terminal pins 5003 extend. Holding ribs 5346U and 5346D hold ends 5017A and 5017B, respectively, of central regions 5017 of terminal pins 5003. Holding ribs 5346U and 5346D reduce the vertical tilt or displacement of terminal pins 5003, thereby facilitating the mounting of the high-voltage transformer according to the fourth embodiment onto the printed-circuit board.

### Fifth Embodiment

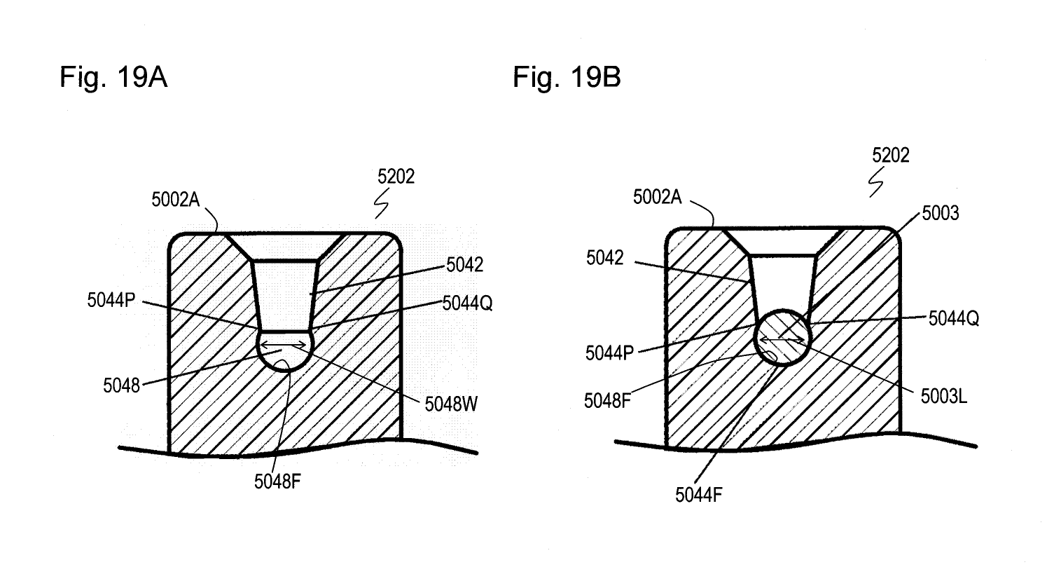

FIG. 21A is a front view of pin holder 5402 of a high-voltage transformer according to a fifth embodiment of the present invention. FIG. 21B is a sectional view of pin holder 5402 taken along line 21B-21B of FIG. 21A. FIG. 21C is a sectional view of pin holder 5402 in the state of holding terminal pin 5003. In FIGS. 21A to 21C, like components are labeled with like reference numerals with respect to FIGS. 20A to 20D showing pin holders 5302, and the description thereof will be omitted.

The high-voltage transformer according to the fifth embodiment includes pin holders 5402 instead of pin holders 5302 of the high-voltage transformer according to the fourth embodiment. Pin holders 5402 each include pin holding ribs 5402L and 5402R extending from front face 5402A, and pin holding projection 5402B instead of pin holding ribs 5302L and 5302R and pin holding projection 5302B of pin holders 5302. Pin holding ribs 5402L and 5402R have the same shapes as pin holding ribs 5302L and 5302R, respectively, of pin holders 5302, but do not face each other, unlike pin holding ribs 5302L and 5302R of pin holders 5302.

As shown in FIG. 21B, when projected onto plane 5402P perpendicular to the direction in which central regions 5017 of terminal pins 5003 extend, pin holders 5402 have the same shape as pin holders 5302 of FIGS. 20A to 20D.

Pin holding ribs 5402L and 5402R, when projected onto plane 5402P, have tips 5451L and 5451R whose spacing is larger than diameter 5003L of terminal pins 5003. Pin holding ribs 5402L and 5402R have surfaces 5450L and 5450R extending from tips 5451L and 5451R. When projected onto plane 5402P, surfaces 5450L and 5450R have a spacing therebetween, which decreases as approaching from tips 5451L and 5451R to front face 5402A, that is, central regions 5017 of terminal pins 5003. Pin holding ribs 5402L and 5402R further have surfaces 5445L and 5445R extending from surfaces 5450L and 5450R. Surfaces 5445L and 5445R are parallel to each other and have a spacing therebetween smaller than diameter 5003L when projected onto plane 5402P. Surfaces 5445L and 5445R have edges 5444L and 5444R in contact with central regions 5017 of terminal pins 5003. Pin holding ribs 5402L and 5402R further have portions 5446L and 5446R extending from edges 5444L and 5444R toward front face 5402A. Portions 5446L and 5446R projected onto plane 5402P have a spacing therebetween larger than diameter 5003L. Pin holding ribs 5402L and 5402R further have portions 5447L and 5447R extending from portions 5446L and 5446R toward front face 5402A. Portions 5447L and 5447R projected onto plane 5402P have a spacing therebetween larger than the spacing between portions 5446L and 5446R projected onto plane 5402P.

The upper left of the cross section of terminal pins 5003 is held by edge 5444L of pin holding rib 5402L, and the bottom of terminal pins 5003 is held by upper surface 5444G of pin holding projection 5402B. The upper right of the cross section of terminal pins 5003 is held by edge 5444R of pin holding rib 5402R, and the bottom of terminal pins 5003 is held by upper surface 5444H of pin holding projection 5402B. When pin holder 5402 is viewed as a whole, terminal pin 5003 is held at three points: pin holding projection 5402B and edges 5444L, 5444R. This facilitates the mounting of the high-voltage transformer according to the fifth embodiment onto the printed-circuit board.

In the high-voltage transformer according to the fifth embodiment of the present invention, the projected portions have a larger spacing than rib holders 5002 to 5302 of the third and fourth embodiments. This increases the strength of the mold so as to prevent damage or abrasion thereof, thereby increasing the mold life.

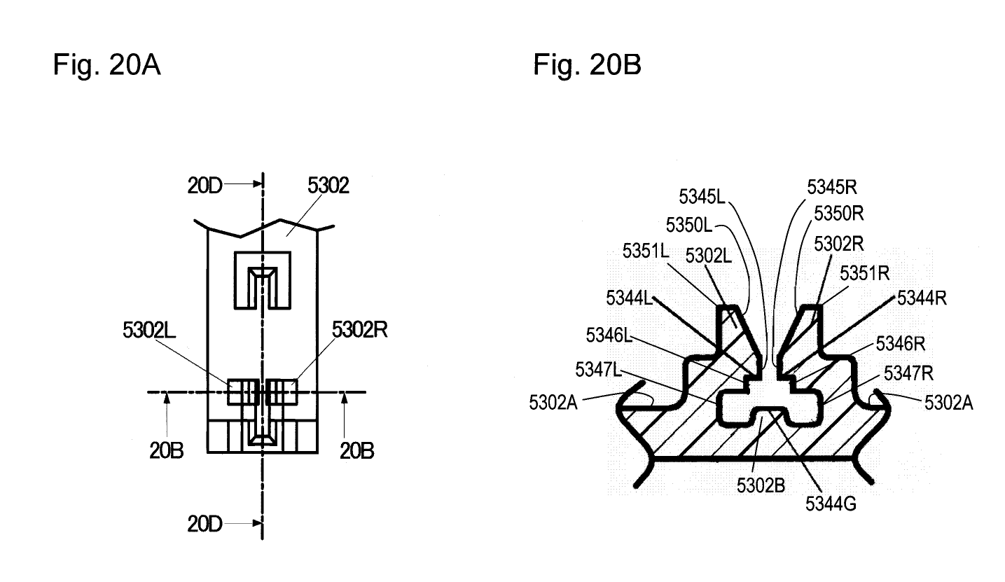

FIG. 22 is a sectional view of pin holder 5402 taken along line 22-22 of FIG. 21A. Upper surface 5444G of pin holding projection 5402B is in contact with central regions 5017 of terminal pins 5003. Edges 5444L and 5444R of pin holding ribs 5402L and 5402R and upper surface 545454G of pin holding projection 5402B are in contact with central regions 5017 of terminal pins 5003, thereby stably fixing terminal pins 5003. This prevents terminal pins 5003 from being displaced or detached from pin holders 5402. Pin holders 5402 each include holding ribs 5446D and 5446U, which have the same function and effect as holding ribs 5346D and 5346U of FIG. 20D.

The structure of the high-voltage transformer according to the third to fifth embodiments is applicable to high-voltage transformer 4310 of FIG. 1 or high-voltage transformer 7301 of FIG. 7 to provide the same effect.

### Sixth Embodiment

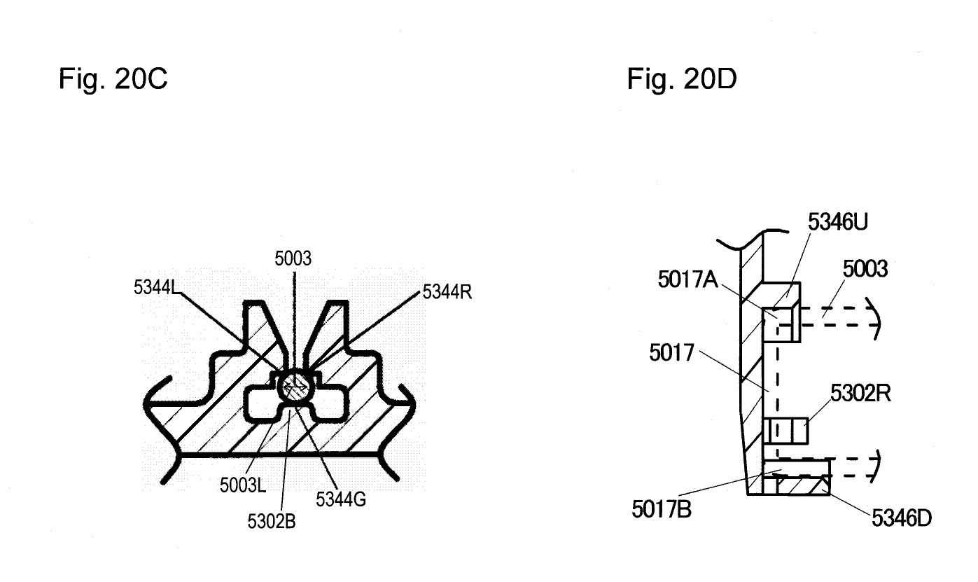

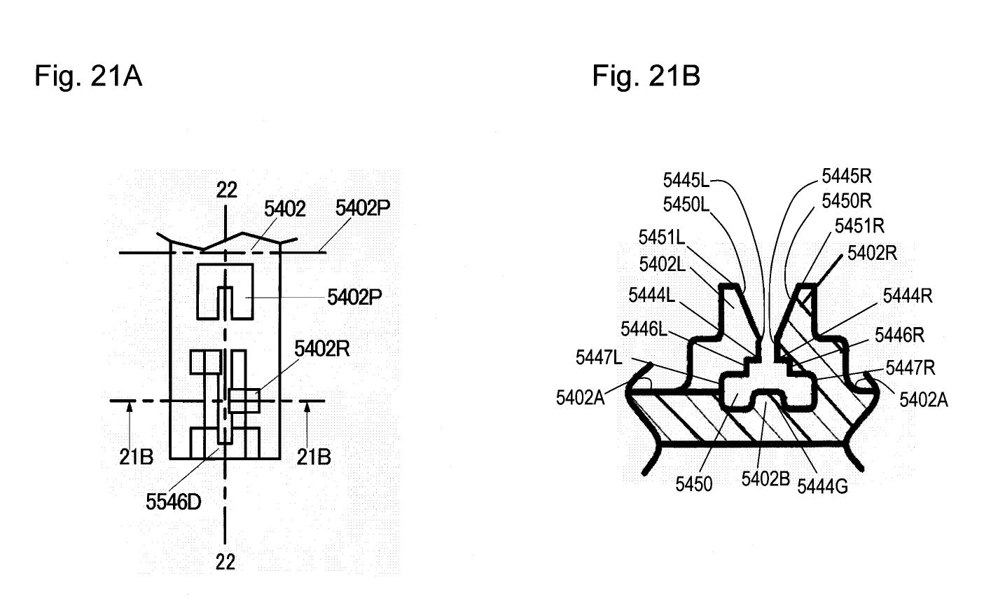

FIG. 23 is a perspective view of high-voltage transformer 1010 according to a sixth embodiment of the present invention. FIG. 24 is a schematic diagram of display device 7001 having high-voltage transformer 1010. High-voltage transformer 1010 includes core 1015, primary coil bobbin 1020, secondary coil bobbin 1040, outer case 1080, and printed-circuit board 1090. Outer case 1080 has a substantially rectangular parallelepiped shape. Outer case 1080 includes holes 1086 for fixing high-voltage transformer 1010 to vertical printed-circuit board 1101 by screws. Printed-circuit board 1090 includes terminal pins 1075 for electrically connecting high-voltage transformer 1010 to vertical printed-circuit board 1101. Thin display device 7001 includes display device portion 1103 and vertical printed-circuit board 1101. Vertical printed-circuit board 1101 is mounted with high-voltage transformer 1010. Terminal pins 1075 of high-voltage transformer 1010 are electrically connected to vertical printed-circuit board 1101. Outer case 1080 includes outwardly curved surface portions 1089A rounded to form a cylindrical shape. Outwardly curved surface portions 1089A have cylindrical inner walls with radius of curvature 1080B. Vertical printed-circuit board 1101 includes notch 1102 for housing outwardly curved surface portions 1089A. Holes 1086 of high-voltage transformer 1010 and the holes formed in vertical printed-circuit board 1101 are fixedly screwed to each other, allowing high-voltage transformer 1010 to be stably mounted on vertical printed-circuit board 1101.

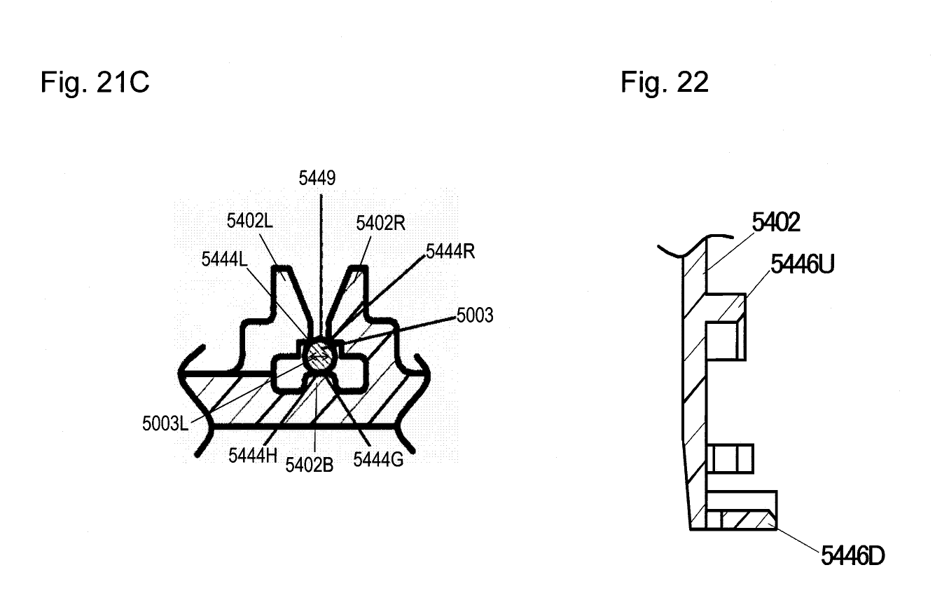

FIGS. 25 to 28 are perspective views of primary coil bobbin 1020, secondary coil bobbin 1040, printed-circuit board 1090, and outer case 1080, respectively, which are main components of high-voltage transformer 1010 before assembly. Primary coil bobbin 1020 is fitted together with secondary coil bobbin 1040 to form a coil part. Printed-circuit board 1090 mounted with the electrical components is combined with the coil part so as to form a transformer body.

As shown in FIG. 25, primary coil bobbin 1020 includes cylindrical part 1021 having hollow part 1021A. Cylindrical part 1021 is provided around its periphery with a plurality of flanges 1022 for separately winding primary winding 1030. Flanges 1022 include notches 1023 for passing the separated windings of the primary winding therethrough. Cylindrical part 1021 includes end 1024 to which terminal block 1025 for holding terminal pins 1035 is attached. Terminal pins 1035 fix the winding-start ends and winding-finish ends of primary winding 1030.

Primary coil bobbin 1020 includes ribs 1027 extending from cylindrical part 1021 and flanges 1022. Ribs 1027 are in contact with the inner wall of outer case 1080 so as to provide electrical isolation between the transformer body and outside high-voltage transformer 1010.

Primary coil bobbin 1020 is molded from a plastic resin. To facilitate the removal from the mold, ribs 1027 are tapered toward tips 1027A. The width of ribs 1027 is, for example, 5 mm at the base and 3 mm at tips 1027A. The tapered shape prevents ribs 1027 from being broken when primary coil bobbin 1020 is pressed into outer case 1080.

Tips 1027A of ribs 1027 are rounded with radius of curvature 1080B of the inner walls of outwardly curved surface portions 1089A so as to be in contact with the inner walls of outwardly curved surface portions 1089A of outer case 1080. Primary coil bobbin 1020 is inserted into outer case 1080 in direction 1020A. Corners 1027B of tips 1027A that face direction 1020A are either plane or chamfered to have a curved surface.

To facilitate the removal from the mold, ribs 1026 are tapered toward tips 1026A. The width of ribs 1026 is, for example, 5 mm at the base and 3 mm at tips 1026A. The tapered shape prevents ribs 1026 from being broken when primary coil bobbin 1020 is pressed into outer case 1080.

Tips 1026A of ribs 1026 are in contact with the inner wall of outer case 1080. Similar to ribs 1027, corners 1026B of tips 1026A that face direction 1020A are either plane or chamfered to have a curved surface. This allows primary coil bobbin 1020 to be inserted into outer case 1080 through opening 1081, while widening the spacing between side surfaces 1089 of outer case 1080.

Two ribs 1026 are arranged in a straight line and come into vertical contact with side surfaces 1089. Two ribs 1027 are arranged in a straight line and come into vertical contact with side surfaces 1089.

Primary coil bobbin 1020 includes gutter 1028 disposed opposite to terminal block 1025 so as to house core 1015.

The plastic resin which forms primary coil bobbin 1020 is a glass-fiber-containing plastic material. Cylindrical part 1021, flanges 1022, terminal block 1025, ribs 1026, 1027, and gutter 1028 are integrally molded from the plastic material to form the primary coil bobbin.

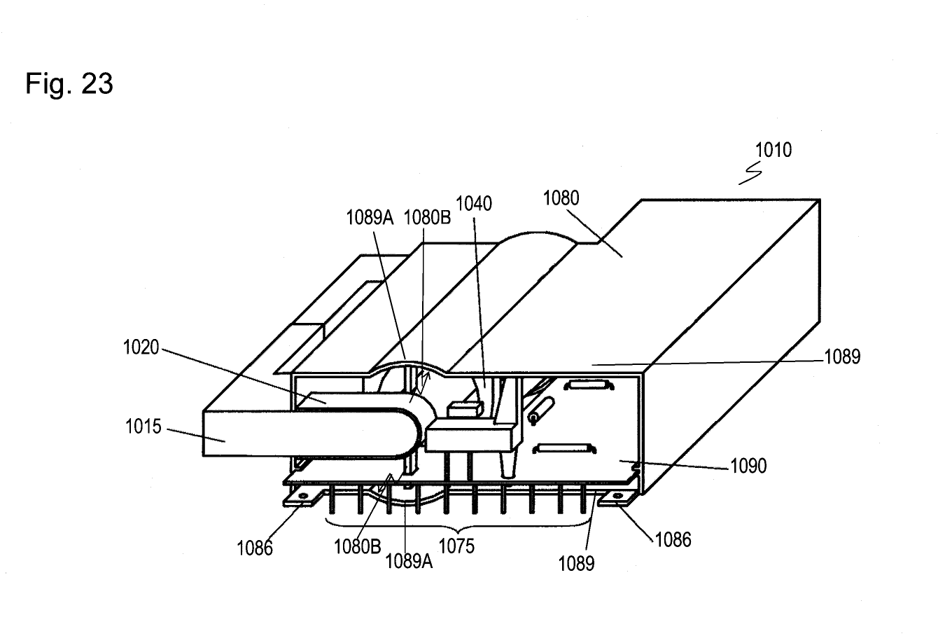

As shown in FIG. 26, secondary coil bobbin 1040 includes cylindrical part 1041 having hollow part 1041A, flanges 1047, terminal blocks 1042, and terminal pins 1055. Cylindrical part 1041 is provided around its periphery with secondary windings 1050 divided into a plurality of portions 1050A and wound thereon. Between portions 1050A of secondary windings 1050 are interposed insulator films 1060. Flanges 1047 prevent films 1060 from adhering to the ends of secondary windings 1050. Terminal blocks 1042 have terminal pins 1055 buried therein to fix the winding-start ends and winding-finish ends of portions 1050A of secondary windings 1050.

Hollow part 1041A of cylindrical part 1041 of secondary coil bobbin 1040 has inner side surface 1043 including rails 1044, a stopper projection, and a return prevention projection, which are integrally molded. Rails 1044 guide primary coil bobbin 1020 to prevent its rotation while being fitted together. The stopper projection is in contact with primary coil bobbin 1020 to prevent it from being inserted too far into hollow part 1041A. The return prevention projection is engaged with primary coil bobbin 1020 to prevent primary coil bobbin 1020 from being detached from hollow part 1041A.

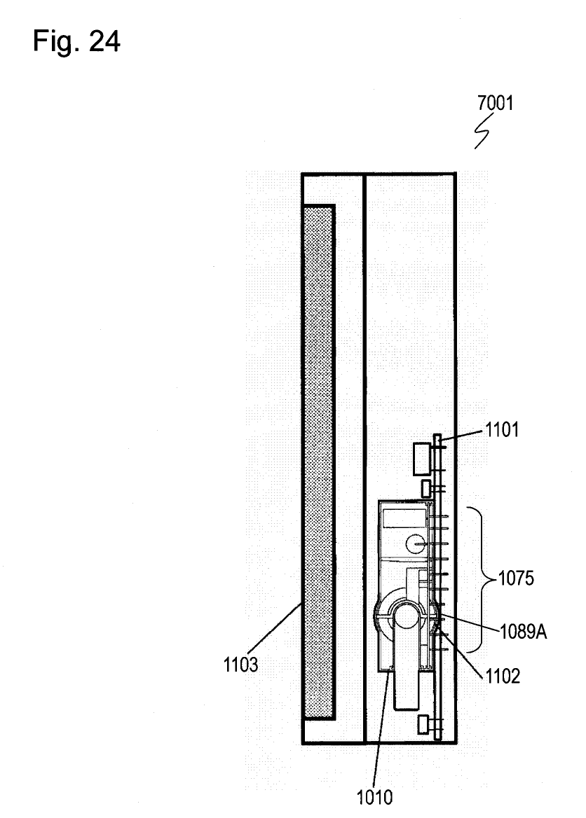

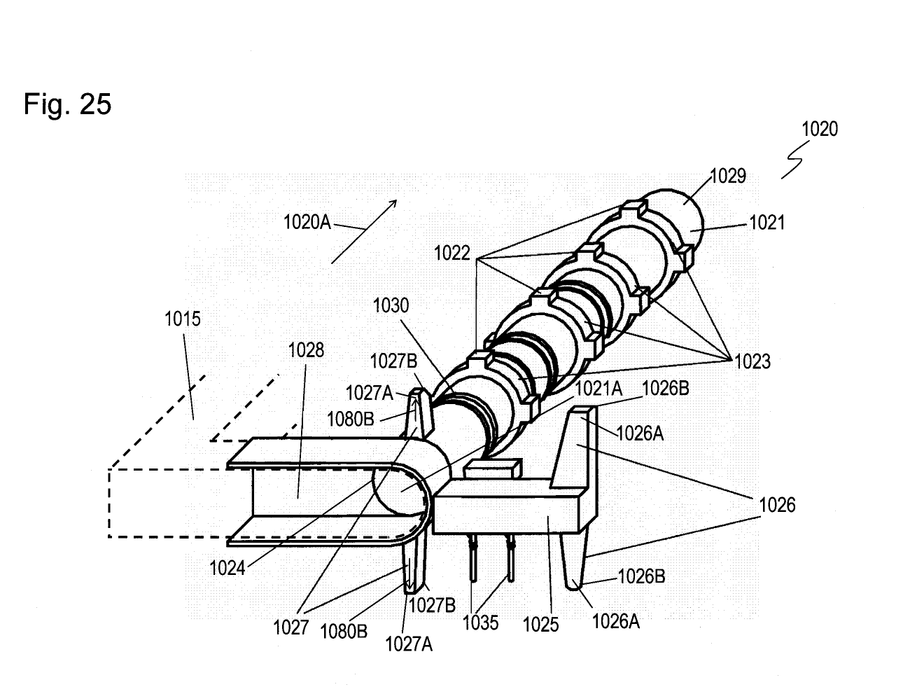

As shown in FIG. 27, printed-circuit board 1090 includes electronic components 1070 in the long side direction of the transformer body so as not to increase the thickness of the transformer body in the short side direction when assembled. Printed-circuit board 1090 includes notch 1091 for housing secondary coil bobbin 1040 in the state of being sandwiched between outwardly curved surface portions 1089A of outer case 1080 shown in FIG. 28. Printed-circuit board 1101 of display device 7001 is connected to terminal pins 1075 arranged in a straight line collectively along side 1092 of printed-circuit board 1090. Printed-circuit board 1090 includes through-holes 1093 to pass ribs 1026 and 1027 of primary coil bobbin 1020. Board 1090 further includes connection holes 1094 connected to terminal pins 1035 and 1055 of primary coil bobbin 1020 and secondary coil bobbin 1040, respectively.

As shown in FIG. 28, opening 1081 of outer case 1080 is substantially rectangular with facing side surfaces 1089 and facing side surfaces 1089C which connect four corners 1083. Outer case 1080 is made of a plastic material containing glass fiber as a reinforcement and has molding strain toward the inside of opening 1081. As shown in FIG. 23, when primary coil bobbin 1020, secondary coil bobbin 1040, and printed-circuit board 1090 are housed, opening 1081 has a substantially rectangular shape consisting of long sides 1081A, 1081B, and short sides 1081C, 1081D. More specifically, before accommodating primary and secondary coil bobbins 1020, 1040 and printed-circuit board 1090, side surfaces 1089C coincide with short sides 1081C and 1081D, but side surfaces 1089 do not coincide with long sides 1081A and 1081B. Side surfaces 1089 are bent toward the inside of outer case 1080 due to molding strain. As shown in FIG. 23, when primary and secondary coil bobbins 1020, 1040 and printed-circuit board 1090 are housed, ribs 1026 and 1027 are in contact with two facing side surfaces 1089 of outer case 1080. The molding strain of outer case 1080 causes two side surfaces 1089 to bias ribs 1026 and 1027 in the direction in which two side surfaces 1089 approach each other, that is, toward the inside of outer case 1080.

Long sides 1081A and 1081B of rectangular opening 1081 of outer case 1080 are partially swollen to allow the coil part to be fitted thereinto. Electronic components 1070 are arranged in parallel with long sides 1081A and 1081B so that short sides 1081C and 1081D can be fitted within the small depth of display device 7001. In the sixth embodiment, the ratio in length of long sides 1081A and 1081B to short sides 1081C and 1081D of opening 1081 of outer case 1080 is 1.5 or larger, thus achieving thin transformer 1010.

As the ratio in length of long sides 1081A and 1081B to short sides 1081C and 1081D of outer case 1080 increases, the molding strain of outer case 1080 increases. If primary coil bobbin 1020 does not have ribs 1026 and 1027, side surfaces 1089C of outer case 1080 must be longer. The reason is to provide a predetermined insulation distance between the coil part and the outside (side surfaces 1089) of outer case 1080 even when long sides 1081A and 1081B of side surfaces 1089 of opening 1081 are bent.

Ribs 1027 of primary coil bobbin 1020 have a length of 17.5 mm from the center of primary coil bobbin 1020. The reason for this is to make the spacing between side surfaces 1089 of outer case 1080 coincide with imaginary lines 1082A (having a spacing of 35 mm) of outwardly curved surface portions 1089A as shown in dotted lines in FIG. 28. This provides electrical isolation between the transformer body and the outside of high-voltage transformer 1010. The length of ribs 1027 may be other than 17.5 mm, which is half the spacing between imaginary lines 1082A.

Ribs 1026 extend up to side surfaces 1089 perpendicularly from terminal block 1025. Terminal block 1025 extends from the boundaries between outwardly curved surface portions 1089A and linear portions 1089B of opening 1081 as far as approximately 20 mm, which is half the distance to side surfaces 1089C of outer case 1080. In order to make linear portions 1089B of side surfaces 1089 of outer case 1080 coincide with long sides 1081A and 1081B having a spacing of 30 mm, the distance between tips 1026A of ribs 1026 is set to 30 mm, which is equal to the distance between long sides 1081A and 1081B.

Holes 1086 are integrally molded with outer case 1080 so as to fixedly screw high-voltage transformer 1010 to another component.

When the plastic resin used as the material of outer case 1080 does not contain glass fiber, the molding strain may be small enough to dispense with ribs 1026 and 1027 to obtain the predetermined insulation distance between the coil part and the outside of outer case 1080. However, outer case 1080 made of the plastic resin not containing glass fiber is low in strength, possibly causing cracks due to heat stress even in holes 1086.

Side surfaces 1089 have inner surfaces 1085, which are provided with two rail-like projections 1087 for supporting printed-circuit board 1090. Outer case 1080 includes round hole 1088 to accommodate tip 1029 of cylindrical part 1021 of primary coil bobbin 1020 on side surface 1084, which is opposite to opening 1081. Outer case 1080 further includes notch 1080D fitted with gutter 1028 of primary coil bobbin 1020.

The following is a description of a method for manufacturing high-voltage transformer 1010 according to the sixth embodiment.

First, secondary coil bobbin 1040 is fitted around the outer periphery of cylindrical part 1021 of primary coil bobbin 1020 while sliding parts of flanges 1022 of primary coil bobbin 1020 along rails 1044 of secondary coil bobbin 1040. Ribs 1027 are not fitted into secondary coil bobbin 1040, but protrude therefrom.

Next, terminal pins 1055 of secondary coil bobbin 1040 are inserted into holes 1094 of printed-circuit board 1090, thereby being electrically connected to electronic components 1070 while secondary coil bobbin 1040 is placed in notch 1091 of printed-circuit board 1090. Terminal pins 1035 buried in terminal block 1025 of primary coil bobbin 1020 are inserted into holes 1094 of printed-circuit board 1090, thereby being electrically connected to electronic components 1070. Ribs 1026 and 1027 are made to pass through through-holes 1093 of printed-circuit board 1090.

Next, primary and secondary coil bobbins 1020, 1040 and board 1090 are inserted into outer case 1080 while sliding side surfaces 1095 of printed-circuit board 1090 through opening 1081 of outer case 1080 into between rail-like projections 1087. When inserted through opening 1081 of outer case 1080, primary coil bobbin 1020 extends to the inner side surfaces of long sides 1081A and 1081B (straight imaginary lines 1082B) connecting between corners 1083 of opening 1081 of outer case 1080. Tips 1026A and 1027A of ribs 1026 and 1027 of primary coil bobbin 1020 are pressed into opening 1081 so as to make linear portions 1089B and outwardly curved surface portions 1089A coincide with imaginary lines 1082B and 1082A, respectively.

Tip 1029 of cylindrical part 1021 of primary coil bobbin 1020 is fitted into round hole 1088 of outer case 1080. Gutter 1028 of primary coil bobbin 1020 is fitted into the square bracket-shaped notch of outer case 1080.

Side 1092 of printed-circuit board 1090 having terminal pins 1075 thereon protrudes from opening 1081 of substantially rectangular outer case 1080.

Printed-circuit board 1090 is disposed in parallel with the longitudinal direction of outer case 1080, and the notches are formed in the primary and secondary coil bobbins. This reduces the thickness of the high-voltage transformer in the short side direction, thus allowing high-voltage transformer 1010 to be disposed in the limited space of thin display device 7001.

Outer case 1080 made of the glass-fiber-containing plastic material has a large molding strain; however, the thickness can be determined accurately using ribs 1026 and 1027.

### Seventh Embodiment

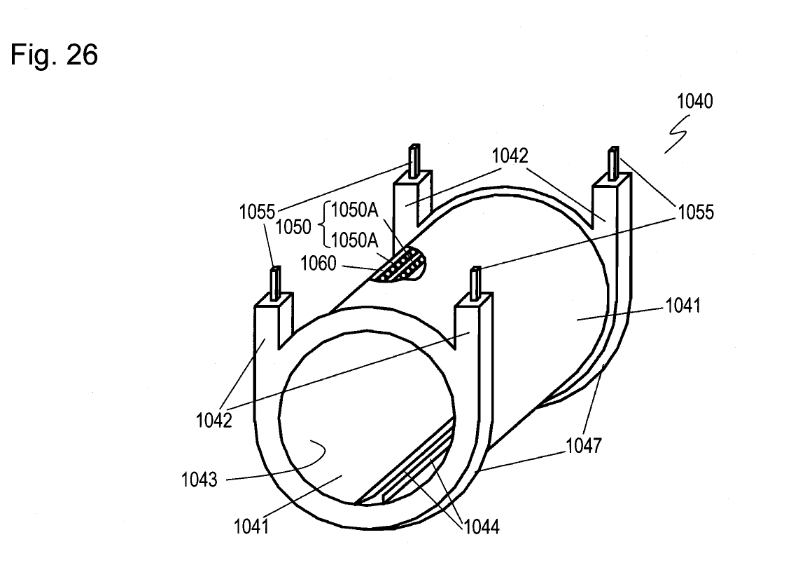

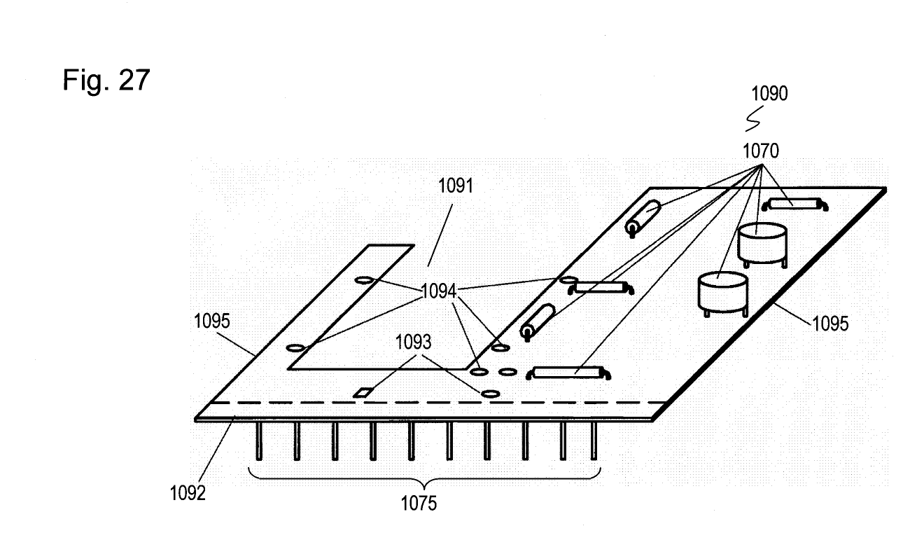

FIGS. 29 and 30 are perspective views of high-voltage transformers 1901 and 1902, respectively, according to a seventh embodiment. In FIGS. 29 and 30, like components are labeled with like reference numerals with respect to FIGS. 23 to 28, and the description thereof will be omitted.

When outer case 1080 has a small molding strain, one of ribs 1026 and 1027 can be omitted. In high-voltage transformer 1901 of FIG. 29, primary coil bobbin 1020 includes ribs 1026, but not ribs 1027. In high-voltage transformer 1902 of FIG. 30, primary coil bobbin 1020 includes ribs 1027, but not ribs 1026.

Similar to high-voltage transformer 1010 according to the sixth embodiment, high-voltage transformers 1901 and 1902 have a small thickness in the short side direction.

### Eighth Embodiment

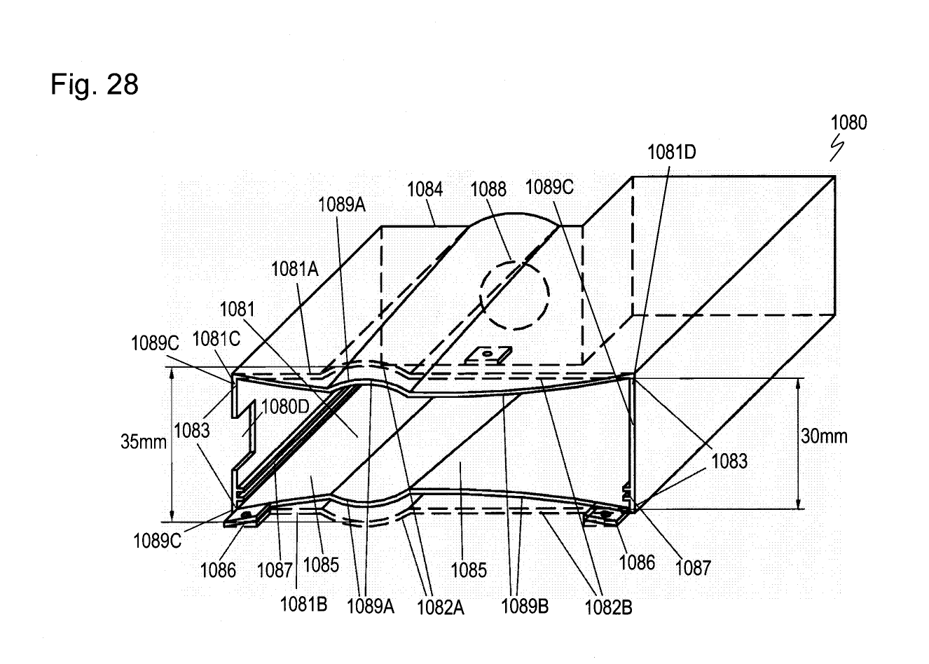

FIG. 31 is a bottom view of high-voltage transformer 1903 according to an eighth embodiment. In FIG. 31, like components are labeled with like reference numerals with respect to FIGS. 23 to 28, and the description thereof will be omitted.

High-voltage transformer 1903 includes support bars 1800 and 1810 instead of ribs 1026 and 1027 of primary coil bobbin 1020 of high-voltage transformer 1010 shown in FIGS. 23 to 28. Support bars 1800 and 1810 are separate from coil bobbins 1020 and 1040. Support bar 1800 is fixedly inserted into the hole of printed-circuit board 1090. Support bar 1810 includes U-shaped portion 1810A and portions 1810B extending from both ends of portion 1810A. U-shaped portion 1810A is fixed along the circular arc of the end of cylindrical part 1021 of primary coil bobbin 1020.

The spacing between the tips of support bar 1800 is equal to the spacing between imaginary lines 1082B of outer case 1080. The spacing between the tips of U-shaped support bar 1810 is set to, for example, 35 mm, which is equal to the spacing between imaginary lines 1082A of outer case 1080.

When the transformer body is housed in outer case 1080, both ends of each of support bars 1800 and 1810 fixed to primary coil bobbin 1020 and printed-circuit board 1090, respectively, are in contact with the inner wall of outer case 1080. This allows the inner wall of outer case 1080 to be positioned in the imaginary lines, thereby securing an insulation distance of 3 mm between the transformer body and the outside of outer case 1080.

### Ninth Embodiment

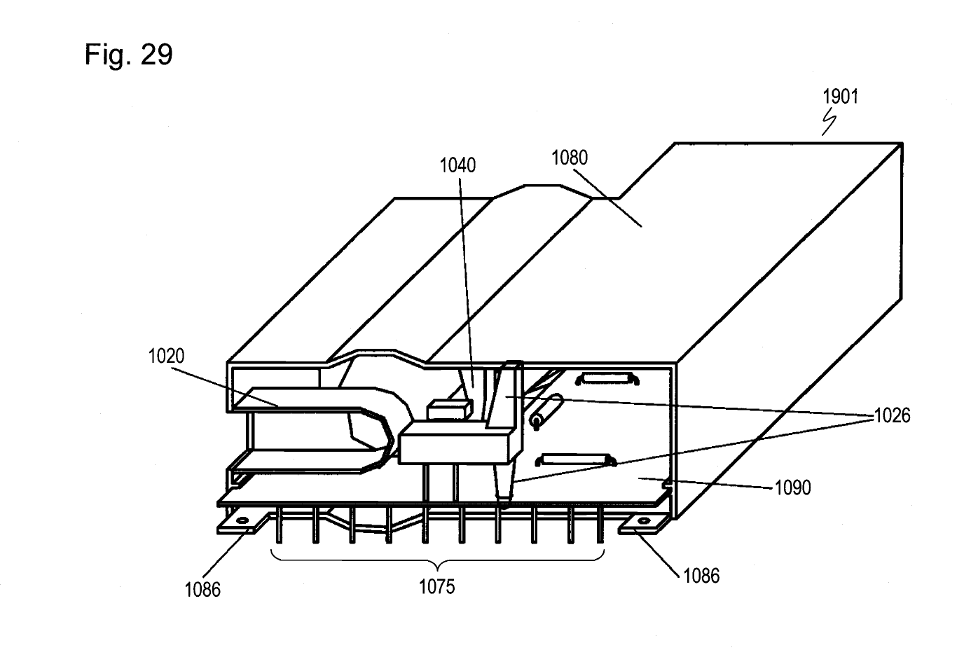

FIG. 32 is an exploded perspective view of high-voltage transformer 1904 according to a ninth embodiment. In FIG. 32, like components are labeled with like reference numerals with respect to FIGS. 23 to 28, and the description thereof will be omitted.

High-voltage transformer 1904 according to the ninth embodiment includes supporting plate 1600 substantially the same in shape as opening 1081 of outer case 1080, instead of ribs 1026 and 1027 of primary coil bobbin 1020. Supporting plate 1600 is disposed in opening 1081 of outer case 1080.

When disposed in opening 1081 of outer case 1080, supporting plate 1600 is provided with hole 1601 for pouring insulating resin into case 1080. Supporting plate 1600 is further provided with notch 1602 in which terminal pins 1075 and side 1092 of printed-circuit board 1090 are disposed.

In supporting plate 1600, facing side surfaces 1089 of case 1080 are spread out to coincide with imaginary lines 1082B and 1082A, respectively. This ensures the distance of 3 mm required to provide electrical isolation between the transformer body and the outside of outer case 1080.

In high-voltage transformer 1904, supporting plate 1600 substantially the same in shape as opening 1081 of outer case 1080 allows a reduction in thickness of outer case 1080 in the short side direction, without making the shape of primary coil bobbin 1020 complex.

Supporting plate 1600 is placed in opening 1081 after the transformer body is inserted into case 1080, allowing transformer 1904 to be manufactured with high efficiency.

### Tenth Embodiment

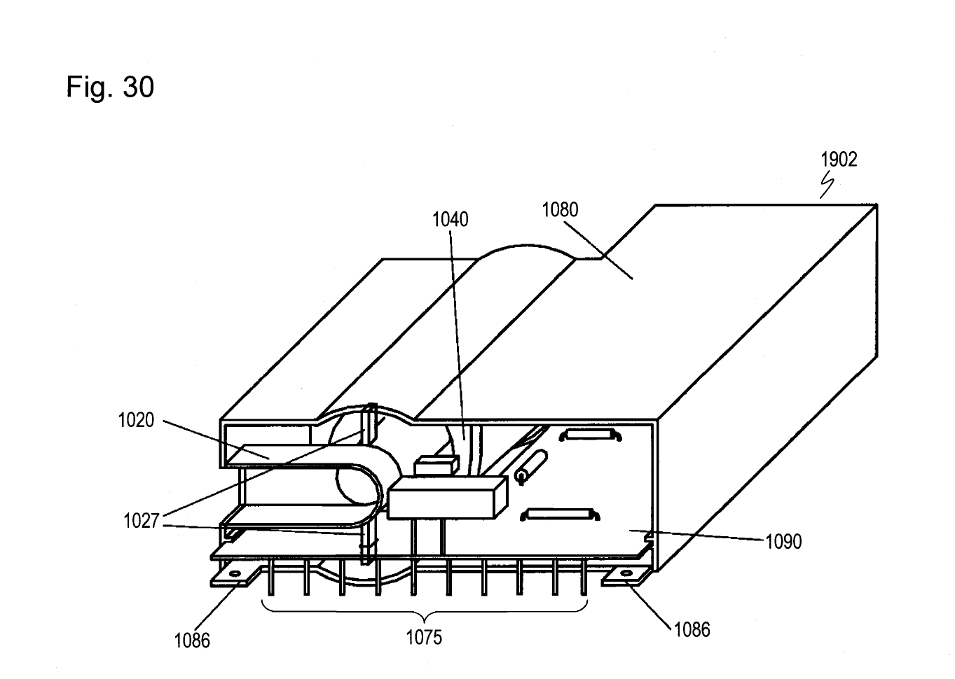

FIG. 33 is a bottom view of high-voltage transformer 1905 according to a tenth embodiment. In FIG. 33, like components are labeled with like reference numerals with respect to FIGS. 23 to 28, and the description thereof will be omitted.

In high-voltage transformer 1905, one of the two side surfaces of the facing long sides of substantially rectangular opening 1081 of outer case 1080 has outwardly curved surface portion 1900, and the other of the side surface is flat. Ribs 1027 of primary coil bobbin 1020 have square tips.

Since one of the side surfaces of outer case 1080 is flat, outer case 1080 has a large molding strain. However, two side surfaces can be spread out by ribs 1026 and 1027 so as to reduce the thickness of high-voltage transformer 1905 in the short side direction.

### Eleventh Embodiment

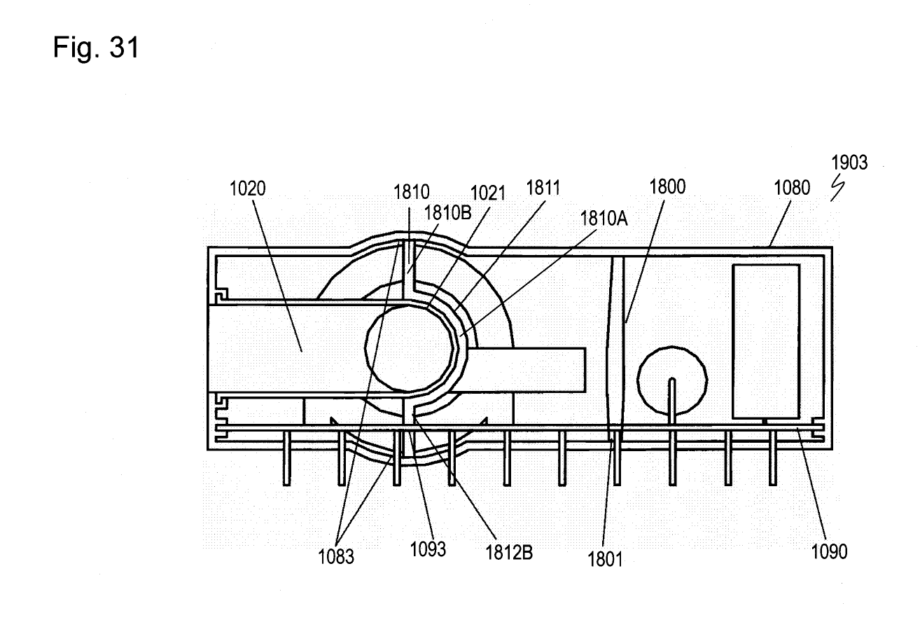

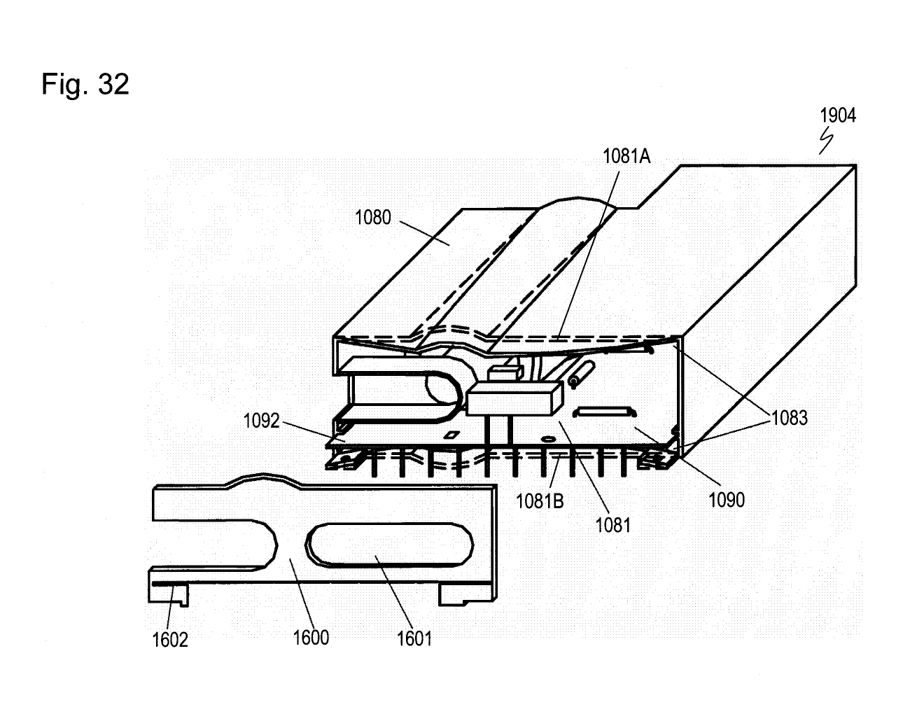

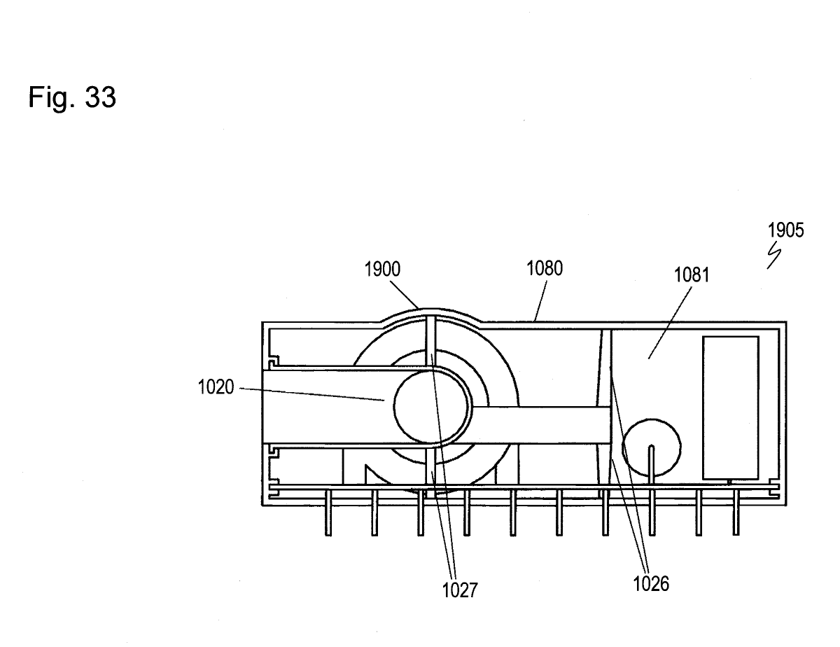

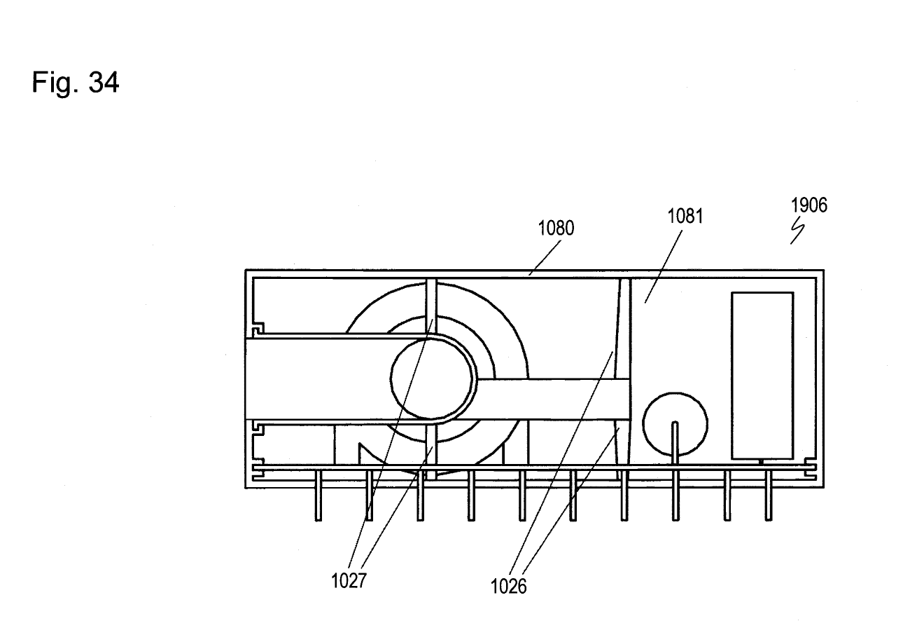

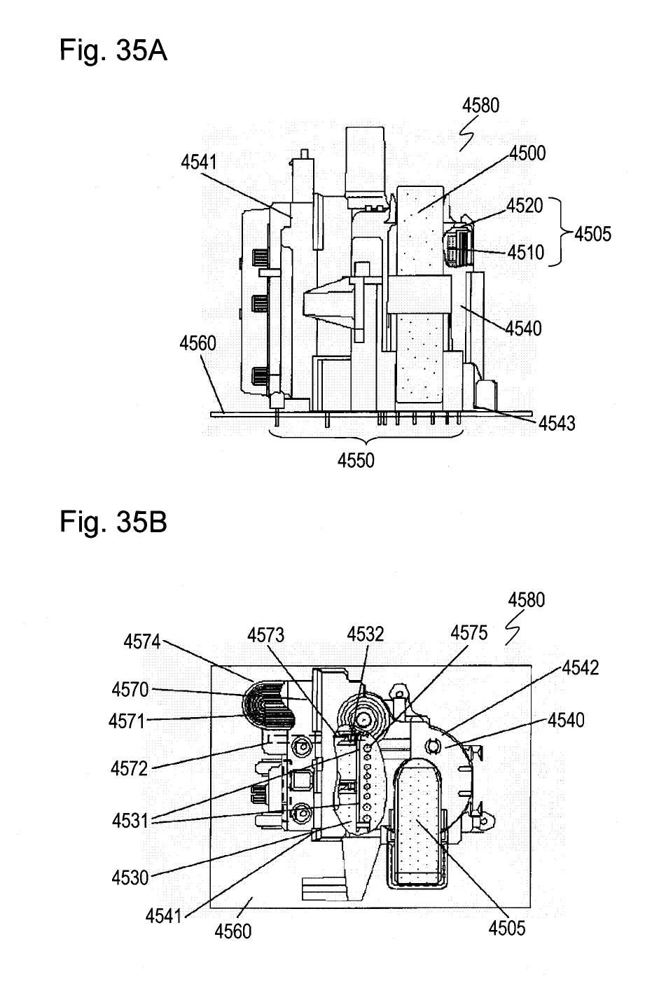

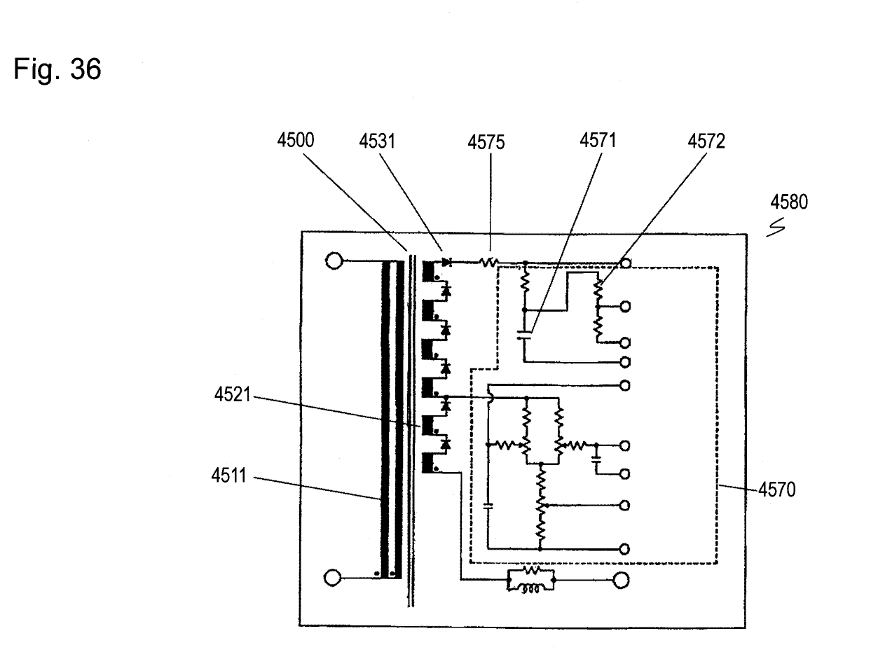

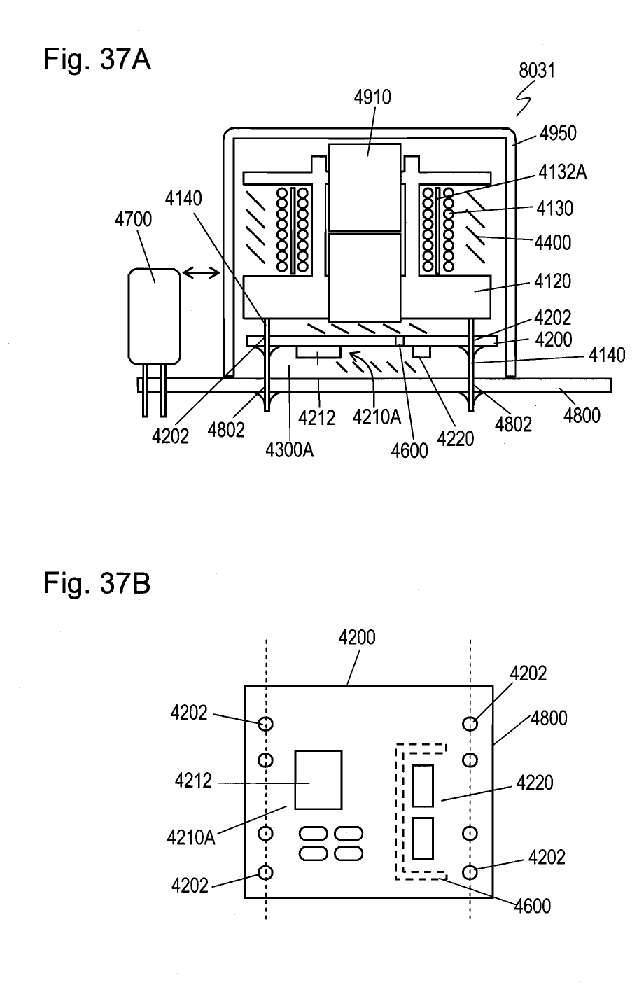

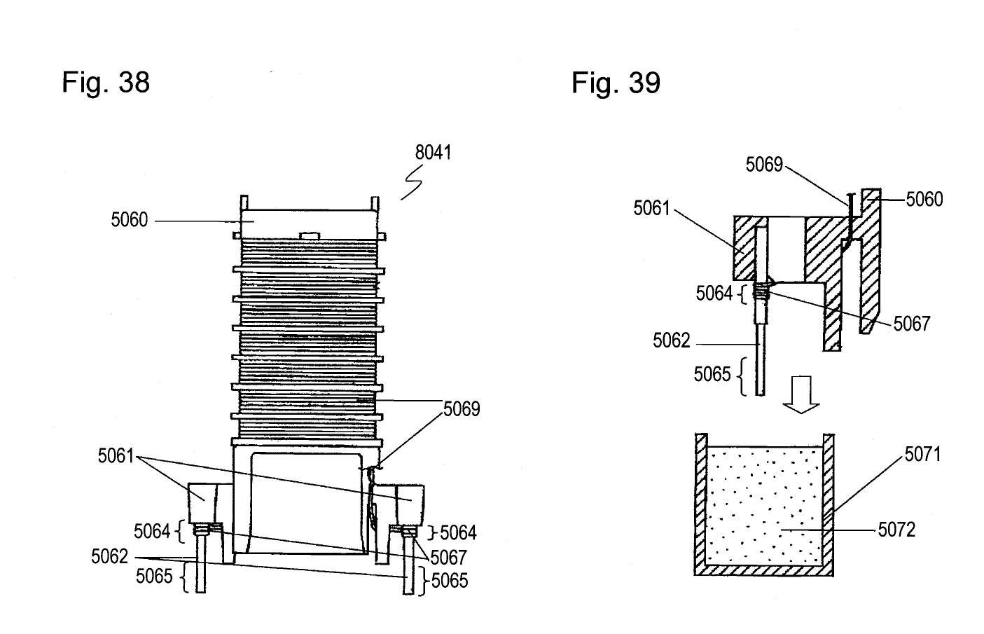

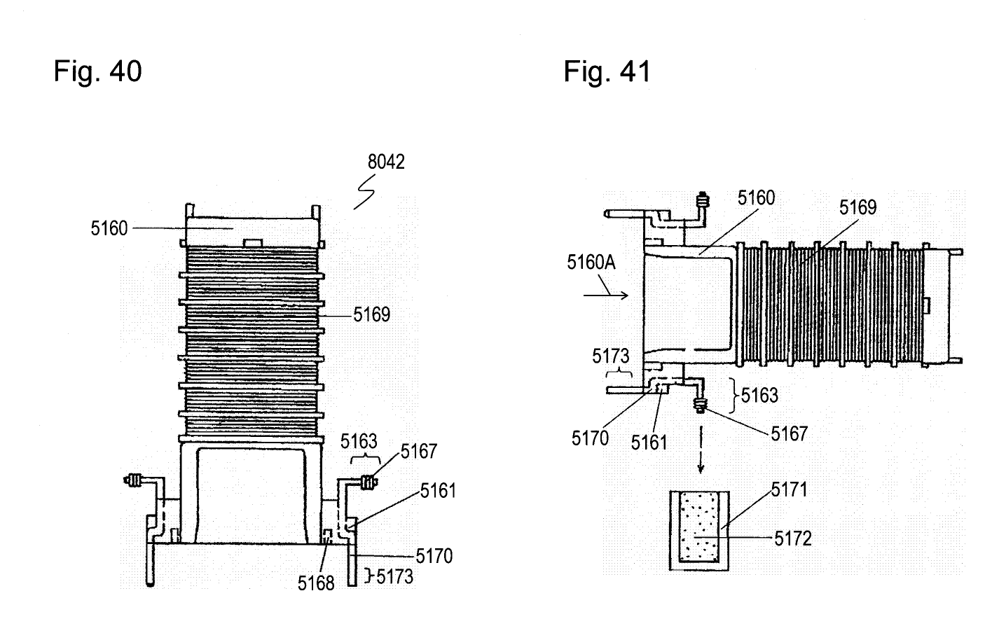

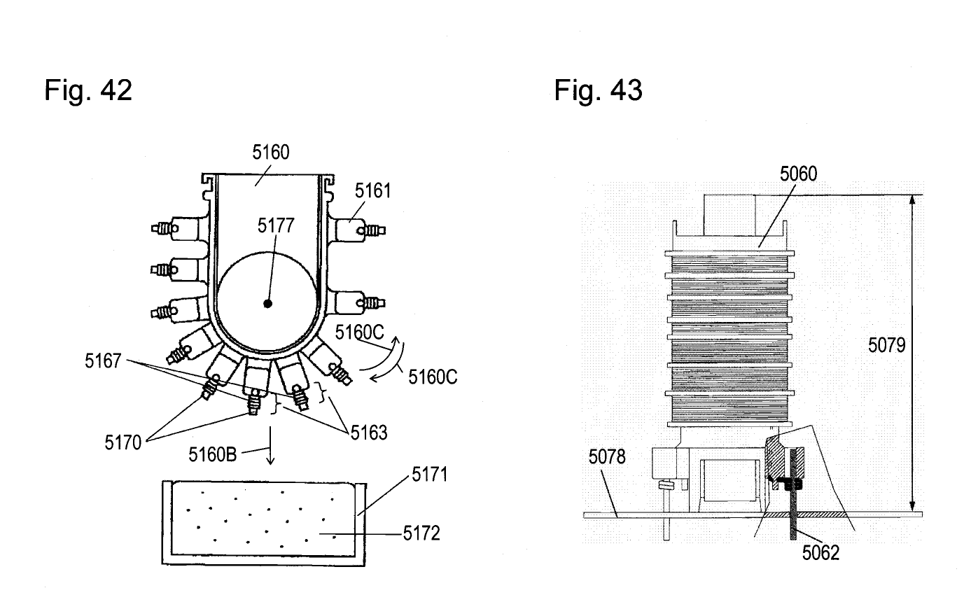

FIG. 34 is a bottom view of high-voltage transformer 1906 according to an eleventh embodiment. In FIG. 34, like components are labeled with like reference numerals with respect to FIGS. 23 to 28, and the description thereof will be omitted.

Opening 1081 of outer case 1080 of high-voltage transformer 1906 has a rectangular shape. In other words, the two side surfaces of the facing long sides of opening 1081 of outer case 1080 are both flat.

In this structure, outer case 1080 has a larger molding strain; however, the two side surfaces can be spread out by ribs 1026 and 1027 so as to securely reduce the thickness in the short side direction.

The structure of high-voltage transformers 1010 and 1901 to 1906 according to the sixth to eleventh embodiments is applicable to high-voltage transformer 4310 of FIGS. 1A and 1B, high-voltage transformer 7301 of FIG. 7, and the high-voltage transformer according to the third to fifth embodiments to provide the same effect.

### INDUSTRIAL APPLICABILITY

The high-voltage transformer is low-profile and small enough to be suitable for a device using a high voltage.

1. A high-voltage transformer comprising:
a coil part including:
a core;
a primary coil bobbin into which the core is inserted; and
a primary winding wound around the primary coil bobbin;
a secondary coil bobbin in which the primary coil bobbin is disposed; and
a secondary winding wound around the secondary coil bobbin:
a diode holder including:
a plurality of diodes connected to the winding; and
a first member to which the diodes are attached;
a component block including:
an electrical component connected to the winding; and
a second member to which the electrical component is attached;
an outer case for housing the coil part, the diode holder, and the component block, the outer case being substantially rectangular parallelepiped shaped;
insulating resin contained in the outer case;
a plurality of first terminal pins connected to a circuit board and to the primary winding, the first terminal pins extending perpendicular to a longitudinal direction of the primary coil bobbin; and
pin holders for holding the first terminal pins.

2. The high-voltage transformer of claim 1, wherein
the primary coil bobbin has a center line around which the primary winding is wound;
the outer case includes;
a first side surface parallel with the center line of the primary coil bobbin and perpendicular to the first terminal pins; and
a second side surface facing the first side surface; and
a distance between a center of the primary coil bobbin of the coil part and the first side surface of the outer case is different from a distance between the center of the primary coil bobbin and the second side surface of the outer case.

3-4. (canceled)

5. The high-voltage transformer of claim 2, wherein
the high-voltage transformer is designed to be mounted on a board in such a manner that the first side surface of the outer case is in contact with the board;
the outer case has an outwardly curved surface portion extending from the second side surface; and
the distance between the center of the coil bobbin of the primary coil part and the first side surface of the outer case is larger than the distance between the center of the primary coil bobbin and the outwardly curved surface portion of the second side surface of the outer case.

6. The high-voltage transformer of claim 1, further comprising a plurality of second terminal pins connected to the circuit board and to the component block, wherein
the coil part, the diode holder, and the component block are arranged in a straight line in a predetermined direction.

7. The high-voltage transformer of claim 1, further comprising: a plurality of second terminal pins connected to the circuit board and to the component block, the second terminal pins extending perpendicular to the longitudinal direction of the primary coil bobbin.

8. (canceled)

9. The high-voltage transformer of claim 7, wherein
the outer case includes an aperture plane; and
the first terminal pins and the second terminal pins are arranged in a straight line on the aperture plane of the outer case.

10. The high-voltage transformer of claim 7, wherein
the electrical component of the component block includes a high-voltage protection resistor;
the outer case includes a protruding part protruding away from the second terminal pins; and
the high-voltage protection resistor is housed in the protruding part of the outer case.

11. The high-voltage transformer of claim 7, wherein
the first member of the diode holder includes a holder substrate having:
a first surface mounted with the diodes; and
a second surface opposite to the first surface and including a hollow hole and a square hole, and
the second member of the component block includes:
a component substrate mounted with the electrical component;
a projection extending from the component substrate and inserted into the hollow hole of the holder substrate; and
an engaging portion extending from the component substrate and engaged with the square hole of the holder substrate.

12. The high-voltage transformer of claim 7, wherein
the coil part further includes a connection pin buried in the secondary coil bobbin, the connection pin being connected to the secondary winding and having an acute tip;
one of the diodes includes a lead wire substantially parallel to the connection pin; and
the component block further includes conductive rubber connected to the electrical component, the tip of the connection pin of the coil part being inserted into the conductive rubber.

13-15. (canceled)

16. The high-voltage transformer of claim 1, wherein
each of the first terminal pins include:
a first end around which the primary winding of the primary coil bobbin is wound, the first end extending perpendicular to the longitudinal direction of the primary coil bobbin;
a central region having a length not less than the first end, the central region being fixed to the pin holder and extending in the longitudinal direction of the primary coil bobbin from the first end; and
a second end extending in parallel with the first end from the central region, the second end being larger than the first end.

17. (canceled)

18. The high-voltage transformer of claim 16, wherein
the pin holder has a front face;
the pin holder includes:
a first groove along the central region of the terminal pin, the first groove having an opening, which opens to the front face, and a bottom and being tapered from the opening toward the bottom;
a second groove connected to the bottom of the first groove, the second groove accommodating the central region of the terminal pin;
the opening of the first groove has a width larger than a diameter of the central region;
the bottom of the first groove has a width smaller than the diameter of the central region; and
the second groove has a width not less than the diameter of the central region.

19-22. (canceled)

23. The high-voltage transformer of claim 16, wherein
the pin holder has a front face;
the pin holder includes:
a pin holding projection extending from the front face, the pin holding projection having a top surface in contact with the central region of the terminal pin at a support point;
a first pin holding rib extending from the front face, the first pin holding rib being in contact with the central region of the terminal pin at a position beyond a central axis of the central region of the terminal pin from the support point;
a second pin holding rib extending from the front face, the second pin holding rib facing the first pin holding rib with the terminal pin and the pin holding projection interposed therebetween and being in contact with the central region of the terminal pin at the position beyond the central axis of the central region of the terminal pin from the support point,
the first pin holding rib and the second pin holding rib respectively include a first surface and a second surface parallel to and facing each other at a spacing smaller than a diameter of the terminal pin:
the first pin holding rib and the second pin holding rib respectively include a first portion and a second portion extending to the front face from the first surface and the second surface, respectively;
the first pin holding rib and the second pin holding rib respectively include a third portion and a fourth portion extending to the front face from the first portion of the first pin holding rib and the second portion of the second pin holding rib;
a spacing between the first portion of the first pin holding rib and the second portion of the second pin holding rib is larger than the diameter of the terminal pins; and
a spacing between the third portion of the first pin holding rib and the fourth portion of the second pin holding rib is larger than the spacing between the first portion of the first pin holding rib and the second portion of the second pin holding rib.

24-25. (canceled)

26. The high-voltage transformer of claim 1, wherein
the outer case includes:
a substantially rectangular opening having:
four corners;
short sides extending from the four corners and facing each other; and
long sides extending from the four corners and facing each other, and
two side surfaces facing each other and corresponding to the long sides, wherein
a ratio in length of the long sides to the short sides is not less than 1.5; and
the primary coil bobbin includes two first ribs in contact with the two side surfaces, respectively.

27. (canceled)

28. The high-voltage transformer of claim 26, wherein
the primary coil bobbin further includes two second ribs in contact with the two side surfaces, respectively.

29-31. (canceled)

32. The high-voltage transformer of claim 26, wherein
the outer case is made of a glass-fiber-containing plastic material.

33-34. (canceled)
